(19) United States
(12) Patent Application Publication
(10) Pub. No.: US 2007/0162919 A1
(43) Pub. Date: Jul. 12, 2007

(54) DISC DRIVE AND BASE UNIT

(75) Inventors: Kiyoshi OMORI, Tokyo (JP); Manabu OBATA, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: SONY CORPORATION, Shinagawa-ku (JP)

(21) Appl. No.: 11/617,301

(22) Filed: Dec. 28, 2006

(30) Foreign Application Priority Data
Jan. 12, 2006 (JP) 2006-005288

(51) Int. Cl. G11B 17/04; G11B 19/20

(52) U.S. Cl. 720/700; 720/619; 720/676

(57) ABSTRACT

A disc drive is disclosed. The disc drive includes: a housing into which a disc-shaped recording medium is inserted; a base unit including a disc mount, a disc rotation driving mechanism, an optical pickup, a pickup transferring mechanism, and a pivot support member, the components of the base unit being mounted integrally on a base; and a base lifting mechanism, wherein the pickup transferring mechanism includes a lead screw and a drive unit that rotates the lead screw, the drive unit being provided in the vicinity of the pivot support member.

### CROSS REFERENCES TO RELATED APPLICATIONS

The present invention contains subject matter related to Japanese Patent Application JP 2006-005288 filed in the Japanese Patent Office on Jan. 12, 2006, the entire contents of which are incorporated herein by reference.

### BACKGROUND

1. Technical Field

The present invention generally relates to a disc drive, and more particularly, to a disc drive that records and/or reproduces information signals on and/or from a disc-shaped recording medium, and a base unit mounted on the disc drive.

2. Background Art

Well-known optical discs include purely optical type discs such as CD (compact disc), DVD (digital versatile disc), and BD (Blue-ray Disc), and magneto-optical type discs such as MO (Magneto Optical) and MD (Mini Disc). Moreover, a variety of disc drives are available for use with such types of optical discs and disc cartridges.

There are various types of disc drives. In one type of disc drive, a user opens a lid or door provided on a housing and mounts a disc directly on a turntable that is exposed and accessed from outside with the opening of the lid or door. In another type of disc drive, when a user places a disc on a disc tray that moves horizontally into or out of the housing, the disc is automatically mounted onto a turntable in the disc tray with the disc tray being brought into the housing. In a still another type of disc drive, a user mounts a disc directly on a turntable provided on a disc tray. In these types of disc drives, however, the user needs to open or close the lid or door, bring the disc tray into or out of the housing, or mount the disc onto the turntable.

In addition, there is known a so-called slot-in type disc drive in which a disc is automatically mounted on a turntable when a user inserts the disc through a disc slot formed at a front side of the housing. The slot-in type disc drive is configured to have a pair of guide rollers located opposite to each other with the disc inserted through the disc slot caught therebetween. By rotating the pair of guide rollers in opposite directions, a disc loading operation in which the disc inserted through the disc slot is brought into the housing and a disc ejection operation in which the disc is brought out of the housing through the disc slot are performed.

Mobile electronic devices such as a notebook-sized personal computer having these types of disc drives mounted thereon are demanded to have a further smaller, lighter and slimmer structure. Therefore, the disc drive are also demanded to have a correspondingly smaller, lighter and slimmer structure. In view of these demands, there has been proposed a slot-in type disc drive, in which a plurality of pivoting arms having an abutting portion at a free end thereof abutting the periphery of a disc inserted through a disc slot on a front panel and supported pivotably on a base end thereof rotates in a plane parallel to the disc, thereby performing a disc loading operation for bringing the disc into the housing through the disc slot and a disc ejection operation for bringing the disc out of the housing through the disc slot (see, JP-A-2005-85449 for example). Among those disc drives having a slimmer structure, a super-slim disc drive mounted on the notebook-sized personal computers or the like is typically designed as thin as 12.7 mm, and a disc drive having the same thickness as a hard disk drive (HDD) unit, i.e., as thin as 9.5 mm is also proposed.

The slot-in type disc drive is configured to include an optical pickup that records and/or reproduces information signals on and/or from an optical disc, a base unit that includes a pickup transferring mechanism for transferring the optical pickup in a radial direction of the optical disc, and a base lifting mechanism that moves the base unit to a disc chucking position or a disc releasing position. Specifically, as shown in FIG. 37, a base unit 500 is configured to include a disc mount 501 on which a disc inserted into a housing through a disc slot is mounted, a disc rotation driving mechanism 502 that rotates the disc mounted on the disc mount 501, an optical pickup 503 that records and/or reproduces signals on and/or from the disc being rotated by the disc rotation driving mechanism 502, and a pickup transferring mechanism 504 that transfers the optical pickup 503 between the inner and outer circumferences of the disc. These components are mounted integrally on a base 505. The disc drive mounted on the base unit 500 is configured to have a base lifting mechanism in which a slider such as a driving lever (not shown) moves the base unit 500 about first, second, and third spindles 506, 507, and 508 formed on lateral sides of the base 505. The base 505 is moved about the third spindle 508 along a cam slit (not shown) engaging with the second spindle 507 in a direction indicated by Z in drawing.

The base unit 500 further includes a pair of guide shafts 510 and 511 that guide movement of the pickup transferring mechanism 504. The pickup transferring mechanism 504 is disposed in the vicinity of one of the guide shafts 510 and has a lead screw 512 extending along the diameter direction of the optical disc and a drive motor 513 connected to a base end of the lead screw 512 and configured to rotate the lead screw 512.

The lead screw 512 is rotated by driving the drive motor 513. When the drive motor 513 is driven at a high speed to generate a sufficient torque, those portions of the pickup transferring mechanism 504 contacting with the drive motor 513 are severely worn out. When a pickup base 514 is moved in a state that the pickup base 514 is connected to the lead screw 512 through a gear mechanism, the disc drive may generate greater noise.

In the pickup transferring mechanism 504, it is necessary to drive the drive motor 513 at a high speed to generate a sufficient torque. However, in order to drive the drive motor 513 at a high speed, it is necessary to increase a winding number of a motor coil, thereby increasing the diameter of the motor itself, i.e., the height of the motor. As a result, it is difficult to manufacture the entire apparatus in a slimmer profile.

Although the base unit 500 is moved about the third spindle 508 by the base lifting mechanism, the load of the base unit 500 is concentrated in the vicinity of the disc mount 501 that is disposed apart from the third spindle 508, thereby increasing the moment required for lifting the base unit 500 and decreasing a burden on the base lifting mechanism.

### SUMMARY OF THE INVENTION

The invention is contrived in view of the above-mentioned situations. There is a need for providing a disc drive and a base unit mounted on the disc drive in which the entire apparatus can be manufactured in a slimmer profile and the burden on the base lifting mechanism is reduced, without changing the size of the drive motor.

According to an embodiment of the invention, there is provided a disc drive including a housing into which a disc-shaped recording medium is inserted; a base unit including a disc mount on which the disc-shaped recording medium inserted into the housing is mounted, a disc rotation driving mechanism that rotates the disc-shaped recording medium mounted on the disc mount, an optical pickup that records and/or reproduces information signals on and/or from the disc-shaped recording medium, a pickup transferring mechanism that transfers the optical pickup in a radial direction of the disc-shaped recording medium, and a pivot support member that pivotably supports one end thereof disposed apart from the disc mount, the components of the base unit being mounted integrally on a base; and a base lifting mechanism that moves the base about the pivot support member between a chucking position where the disc-shaped recording medium is mounted on the disc mount and a chucking release position where the disc-shaped recording medium is dismounted from the disc mount, wherein the pickup transferring mechanism includes a lead screw and a drive unit that rotates the lead screw, the drive unit being provided in the vicinity of the pivot support member.

According to another embodiment of the invention, there is provided a base unit including a disc mount on which the disc-shaped recording medium inserted into the housing is mounted, a disc rotation driving mechanism that rotates the disc-shaped recording medium mounted on the disc mount, an optical pickup that records and/or reproduces information signals on and/or from the disc-shaped recording medium, a pickup transferring mechanism that transfers the optical pickup in a radial direction of the disc-shaped recording medium, and a pivot support member that pivotably supports one end thereof disposed apart from the disc mount, wherein the pickup transferring mechanism includes a lead screw and a drive unit that rotates the lead screw, the drive unit being provided in the vicinity of the pivot support member.

In the embodiments of the invention, the drive unit of the pickup transferring mechanism is provided in the vicinity of the pivot support member mounted on the base. Accordingly, the movement due to the lifting operation is decreased compared to the known disc drive in which the drive unit of the pickup transferring mechanism is provided apart from the pivot support member. Therefore, it is possible to use a large-sized drive motor capable of operating at a high speed and manufacture the entire apparatus in a slimmer profile.

In the base unit according to the embodiments of the invention, the drive unit of the pickup transfer mechanism is fixed to the pivot support member serving as a pivot position. Accordingly, the load of the base unit is not concentrated in the vicinity of the disc mount, thereby decreasing the moment required for lifting the base unit and decreasing a burden on the base lifting mechanism.

### BRIEF DESCRIPTION OF THE DRAWINGS

FIG. 1 is a perspective view showing the appearance of an electronic apparatus on which a disc drive according to an embodiment of the invention is mounted.

FIG. 2 is a perspective view showing the appearance of the disc drive according to the embodiment of the invention.

FIG. 3 is an exploded perspective view showing the inner part of the disc drive according to the embodiment of the invention.

FIG. 4 is an exploded perspective view showing the disc drive with a main chassis removed therefrom.

FIG. 5 is a perspective view showing the appearance of a top cover.

FIG. 6 is a perspective view showing the inner part of the disc drive according to the embodiment of the invention.

FIG. 7 is a perspective view showing the appearance of a bottom surface of a bottom case.

FIG. 8 is a perspective view showing a base unit according to an embodiment of the invention.

FIG. 9 is a plan view showing the base unit according to the embodiment of the invention.

FIGS. 10A and 10B are a perspective view showing a movement driving mechanism of a pickup transferring mechanism and an enlarged plan view showing engagement protrusions, respectively.

FIGS. 11A and 11B are sectional views showing a known base unit and a base unit according to an embodiment of the invention, respectively, in which the height of a drive motor is set to h₂.

FIG. 12 is a plan view for explaining an operation of transferring an optical disc when an operation of inserting the optical disc is started.

FIG. 13 is a plan view for explaining the operation of inserting the optical disc when an eject arm is pivoted as the optical disc is inserted.

FIG. 14 is a plan view for explaining the operation of inserting the optical disc when the eject arm and a loading arm are actuated as the optical disc is inserted.

FIG. 15 is a plan view for explaining the operation of inserting the optical disc when the optical disc is transferred to a centering position.

FIG. 16 is a plan view for explaining the operation of inserting the optical disc when the optical disc is released from the ejecting and loading arms and allowed to freely rotate.

FIG. 17 is a plan view for explaining an operation of ejecting the optical disc when the optical disc is in contact with the ejecting and loading arms.

FIG. 18 is a plan view for explaining an operation of ejecting the optical disc when the optical disc is transferred by the ejecting and loading arms.

FIG. 19 is a plan view for explaining an operation of ejecting the optical disc when the optical disc is transferred by the ejecting and loading arms.

FIG. 20 is a plan view for explaining an operation of ejecting the optical disc when the ejecting of the optical disc is stopped at a predetermined position.

FIG. 21 is a perspective view showing a loading cam plate.

FIG. 22 is an exploded perspective view showing the eject arm.

FIG. 23 is a plan view showing a circuit board installed with first to fourth switches and a slider configured to press the switches.

FIG. 24 is a timing diagram showing an operation of loading the optical disc.

FIG. 25 is a timing diagram showing an operation of ejecting the optical disc.

FIG. 26 is a plan view showing the operation of inserting the optical disc when the optical disc is held in a gripped state.

FIG. 27 is a perspective view showing the operation of ejecting the optical disc when the transfer of the optical disc is interrupted by an obstacle that is placed on an ejecting path of the optical disc.

FIG. 28 is an exploded perspective view showing the eject arm provided with a stopper.

FIG. 29 is a plan view showing mechanisms for preventing an erroneous insertion of a small-diameter optical disc.

FIG. 30 is a perspective view showing the disc drive provided with guide protrusions that are disposed on an upper surface of the main chassis to guide pivot movement of the eject arm.

FIGS. 31A and 31B are schematic views showing a pivot trajectory of the eject arm when guided by the guide protrusions, in which FIG. 31A shows a case where the eject arm is placed on the guide protrusion, whereas FIG. 31B shows a case where the eject arm is not placed on the guide protrusion.

FIGS. 32A and 32B are perspective views showing a slider and a sub slider, respectively.

FIG. 33 is a sectional view showing positional relations between a guide pin and a guide opening when it is in (a), (b), and (c) positions, in which (a) represents a chucking release position, (b) represents a disc mounting position, and (c) represents a recording and/or reproducing position.

FIG. 34 is a perspective view showing the positional relation between the guide pin and the guide opening when the base unit is moved downward to the chucking release position.

FIG. 35 is a perspective view showing the positional relation between the guide pin and the guide opening when the base unit is moved upward to the chucking release position.

FIG. 36 is a perspective view showing the positional relation between the guide pin and the guide opening when the base unit is moved upward to the chucking release position.

FIG. 37 is a perspective view showing the appearance of the known base unit.

### DETAILED DESCRIPTION OF PREFERRED EMBODIMENTS

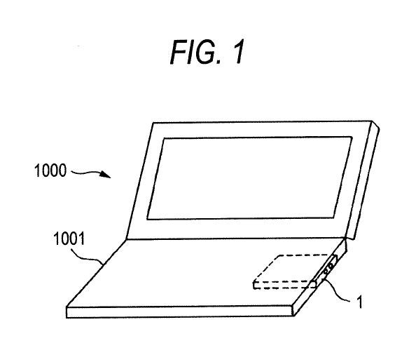

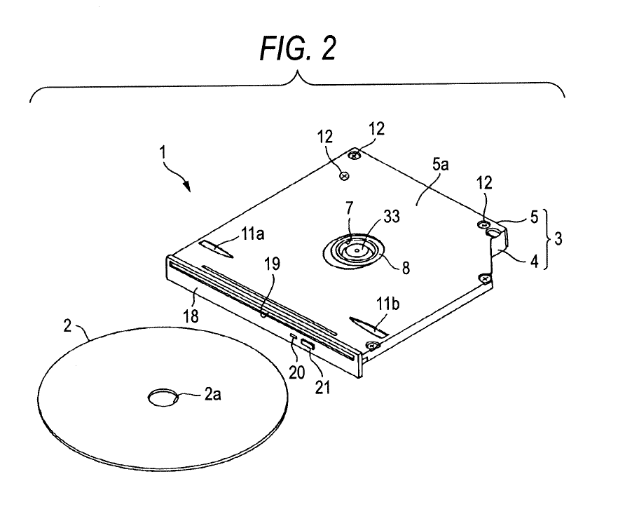

Hereinafter, a disc drive according to an embodiment of the invention will be described with reference to drawings. As shown in FIG. 1, the disc drive 1 is a slot-in type disc drive that is installed in a body 1001 of a notebook-sized personal computer 1000. The disc drive 1 has a structure designed as thin as 12.7 mm, for example, as shown in FIG. 2. The disc drive 1 can record and/or reproduce information signals on and/or from an optical disc 2 such as CD (compact disc), DVD (digital versatile disc), and BD (blue-ray disc).

First, detailed arrangement of the disc drive 1 will be described. As shown in FIGS. 2 to 7, the disc drive 1 includes a housing 3 which constitutes an outer case of the body. The housing 3 is constituted by a generally flat-shaped bottom case 4 serving as a lower housing and a top cover 5 serving as a top plate that covers an upper opening of the bottom case 4. The housing 3 is attached to a main chassis 6 that covers a driving mechanism 120 and a disc conveying mechanism 50 to which a driving force of the driving mechanism 120 is supplied. The driving mechanism 120 upwardly moves a base unit 22 to be described later and supplies the driving force required for conveying the disc.

As shown in FIGS. 2, 3, and 5, the top cover 5 is made of a thin metal plate and includes a top plate 5a that closes the upper opening of the bottom case 4 and a pair of side plates 5b formed by bending a peripheral area of the top plate 5a along lateral sides of the bottom case 4. A generally circular-shaped opening 7 is formed in an approximately central portion of the top plate 5a. The opening 7 serves to guide an engagement protrusion 33a formed on a turntable 23a which engages with a central hole 2a of the optical disc 2 during a disc chucking operation to be described later so that the engagement protrusion 33a is exposed to the outside through the opening 7. An abutment protrusion 8 slightly protruding into the housing 3 so as to abut the periphery of the central hole 2a of the optical disc 2 held on the turntable 23a is formed on the top plate 5a along the periphery of the opening 7.

On a front side of the top plate 5a, there is formed a pair of guide protrusions 11a and 11b swelling into the housing 3 and guiding the optical disc 2 inserted from a disc slot 19 to be described later while limiting a vertical position of the optical disc 2. The guide protrusions 11a and 11b are protruded at locations disposed approximately symmetrical to a center line passing through the opening 7 and extending along the inserting direction of the optical disc 2, thereby depicting a circular arc in the inserting direction of the optical disc 2. Each of the guide protrusions 11a and 11b has a partly conical shape in a direction approximately perpendicular to the inserting direction of the optical disc 2 so that the diameter of the circular arc is continuously decreased toward the inner side of the top plate 5a. That is, the guide protrusions 11a and 11b have a shape in which the cones are divided along an axial line and the apical ends are directed toward the inner side of the top plate 5a. The guide protrusions are continuously lowered and thinned toward the inner side of the top plate 5a.

Since the guide protrusions 11a and 11b have such a shape, it is possible to guide the optical disc 2 smoothly into the housing 3 while correcting any width-directional displacement of the optical disc 2 inserted through the disc slot 19. Moreover, since the top cover 5 is provided with the guide protrusions 11a and 11b having such a shape, it is possible to increase the rigidity of the top plate 5a. The main inner surface of the top plate 5a is processed to have a reduced frictional resistance against the optical disc 2.

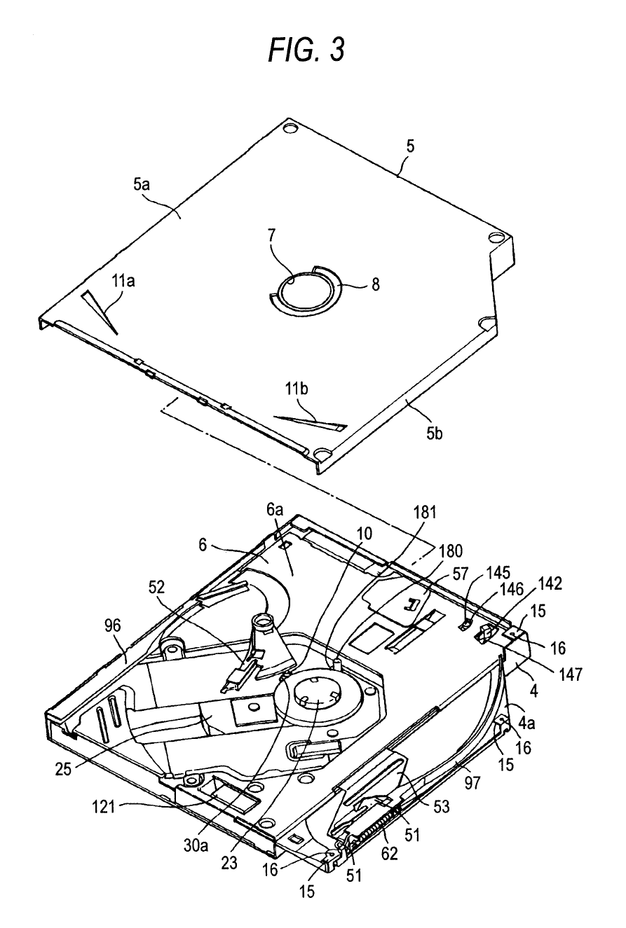

As shown in FIG. 3, the bottom case 4 is made of a metal plate having an approximately flat box shape. The bottom case 4 has a bottom portion having an approximately rectangular shape and a deck portion 4a extending outward from one lateral side of the bottom case 4 and having a bottom surface thereof disposed higher than the bottom portion. A loading arm 51 that brings the optical disc 2 into the housing 3 is pivotably supported on the deck portion 4a, which will be described later.

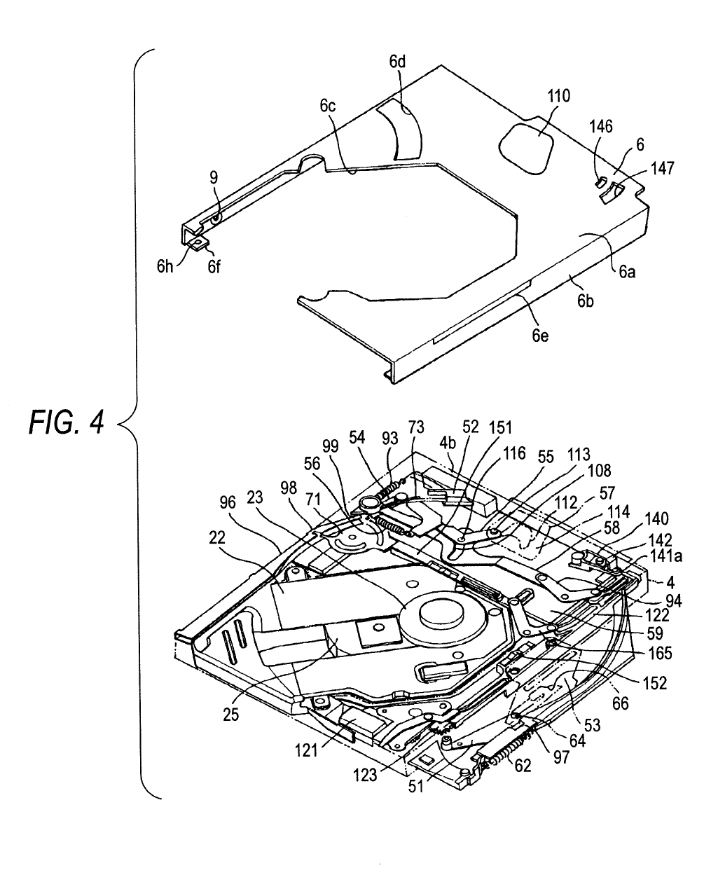

A circuit board 59 having formed thereon electronic components, such as an IC chip, constituting a drive control circuit, connectors for providing electrical connections between various parts, detection switches for detecting operations of the various parts, and the like (see FIG. 4 for reference) is fixed with screws to the rear side of the bottom portion of the bottom case 4 by using screws. A connector opening 4b is formed on a part of the peripheral wall of the bottom case 4 so that the connectors mounted on the circuit board 59 are accessed from the outside through the connector opening 4b.

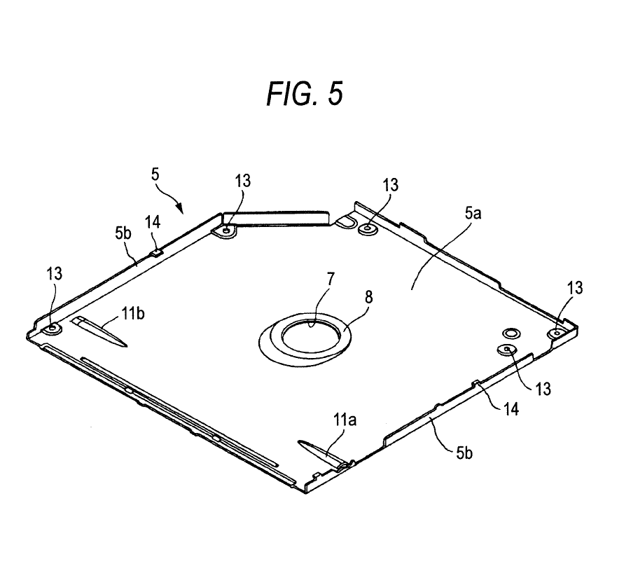

The top cover 5 is fixed with screws to the bottom case 4. Specifically, a plurality of through-holes 13 are formed on the outer circumference of the top plate 5a of the top cover 5 so that screws 12 can pass through the through-holes 13, as shown in FIGS. 2 and 5. A plurality of guide parts 14 bent toward the inside with a right angle is formed on the side plates 5b. A plurality of fixing parts 15 bent toward the inside with a right angle is formed on the outer circumference of the bottom case 4, as shown in FIG. 3. Screw holes 16 are formed on the fixing parts 15 at positions corresponding to the through-holes 13 of the top cover 5. A plurality of guide slits (not shown) are formed on the lateral surfaces of the bottom case 4 so as to prevent the slippage of the guide parts 14 of the top cover 5.

When the top cover 5 is attached to the bottom case 4, the top cover 5 is slid in a direction toward the back side from the front side thereof in a state that the guide parts 14 of the top cover 5 engage with the guide slits of the bottom case 4. As a result, the top plate 5a of the top cover 5 closes the upper opening of the bottom case 4. In this state, the screws 12 are inserted into the screw holes 16 of the bottom case 4 after passing through the through-holes 13 of the top cover 5. With this arrangement, the housing 3 shown in FIG. 2 is constructed.

As shown in FIG. 2, a front panel 18 having an approximately rectangular flat plate shape is attached to the front side of the housing 3. The front panel 18 is provided with a disc slot 19 through which the optical disc 2 is inserted thereto and ejected in a horizontal direction. That is, the optical disc 2 can be inserted into the housing 3 through the disc slot 19 and ejected toward the outside from the housing 3 through the disc slot 19. Moreover, in the disc slot 19, a panel curtain (not shown) is formed at both peripheries in a direction perpendicular to the length-direction of the disc slot 19. The panel curtain is made of non-woven fabric cut in an elongated shape and is adhered with an adhesive agent to the back side of the front panel 18, thereby preventing dust and the like from coming into the housing 3. Moreover, since the panel curtain makes contact with the surface of the optical disc 2 when the optical disc 2 is being inserted and/or ejected, it is possible to remove the dust adhered to the optical disc 2.

On the front side of the front panel 18, there are provided an indicator 20 which illuminates to indicate that the optical disc 2 is being accessed and an eject button 21 which is to be pressed to eject the optical disc 2.

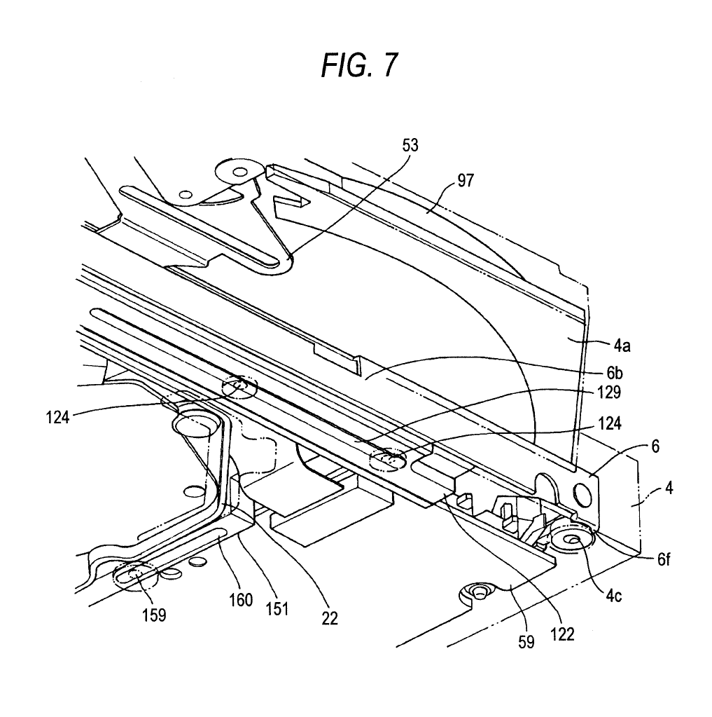

Along a side surface where the deck portion 4a of the bottom case 4 are formed, there are formed a pair of guiding protrusions 124 that slidingly move a slider 122 of the driving mechanism 120 to be described later (see FIG. 7 for reference). The guiding protrusions 124 are separated from each other.

The main chassis 6 is fixed with screws to the bottom portion of the bottom case 4, as shown in FIGS. 3 and 4. The main chassis 6 is disposed above the circuit board 59 and vertically divides the inside of the bottom case 4 at a height approximately equal to that of the deck portion 4a. With this arrangement, the inner portions of the housing 3 disposed vertically closer to the top cover 5 than the main chassis 6 serve as a disc conveying area where the loading arm 51 and the eject arm 52 can freely pivot forward and backward. The inner portions of the housing 3 disposed vertically closer to the bottom case 4 than the main chassis 6 serve as an installing area for first and second link arms 54 and 55, an actuating arm 58, and a loop arm 57 of a disc conveying mechanism 50 that transfers the driving force from the drive motor 121 and the driving mechanism 120 having the drive motor 121 and the slider to the eject arm 52.

The main chassis 6 is made of an approximately flat plate and includes a top surface 6a that extends from the bottom surface of the bottom case 4 to the side surface where the deck portion 4a is formed and covers the bottom case 4 and a pair of side plates 6b formed by bending a peripheral area of the top surface 6a along the lateral sides of the bottom case 4. A base opening 6c and an eject arm opening 6d are formed on the top surface 6a of the main chassis 6 so that the base unit 22 and the eject arm 52 of the disc conveying mechanism 50 can be guided to the conveying area of the optical disc 2 through the base opening 6c and the eject arm opening 6d, respectively. A side plate opening 6e is formed on the side plates 6b where the deck portion 4a is provided; so that a loading cam plate 53 connected to the slider 122 slidingly moved by the driving motor 121 can pass through the side plate opening 6e. The eject arm 52 of the disc conveying mechanism 50 that conveys the optical disc 2 into and out of the housing 3, the actuating arm 58 that transfers the driving force from the driving mechanism 120 to the eject arm 52 to actuate the eject arm 52, and the loop cam 57 that guides the movement of the second link arm 55, which are all disposed on the side of the bottom case 4, are fitted to the top surface 6a of the main chassis 6.

Moreover, a plurality of guide parts 6f bent toward the inside with an approximately right angle is formed on both side plates 6b of the main chassis 6. A plurality of through-holes 6h for fixation with the bottom case 4 are also formed in the guide parts 6f. Screw holes 4c (see FIG. 7) are formed on the bottom case 4 at positions corresponding to the through-holes 6h, and the main chassis 6 is fixed with screws to the bottom case 4 by inserting screws into the screw holes 4c and the through-holes 6h.

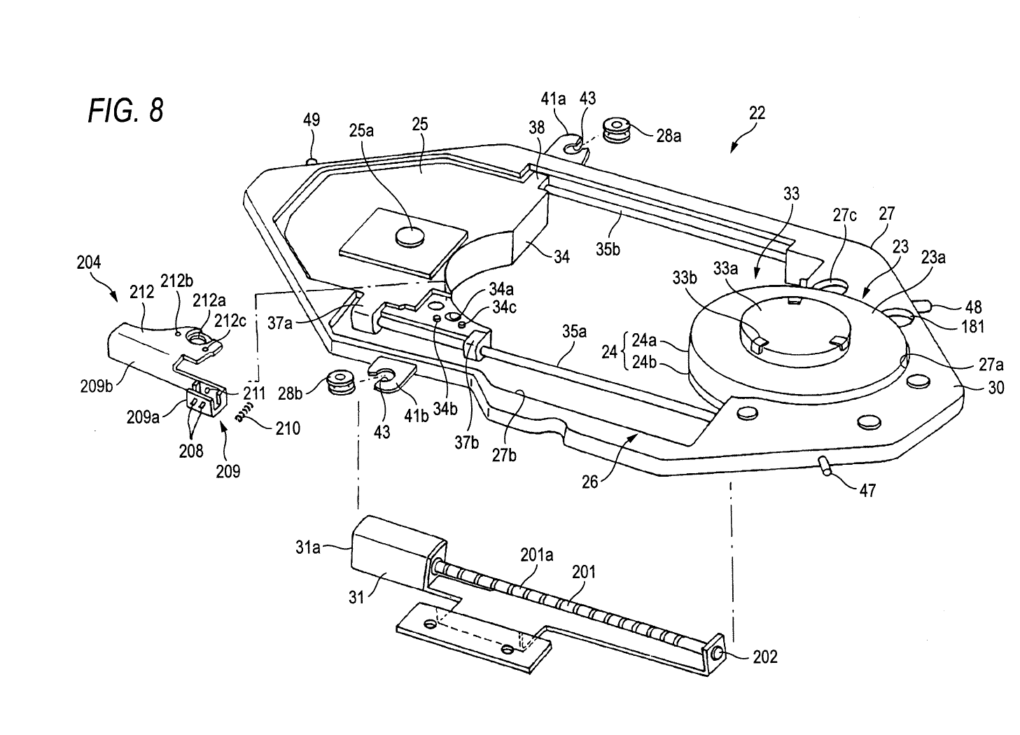

The disc drive 1 includes the base unit 22 provided on the bottom portion of the bottom case 4 to form the drive body. As shown in FIG. 8, the base unit 22 includes a base chassis 27 having an approximately rectangular frame shape, and the base chassis 27 is supported by the bottom case 4 through a plurality of dampers 28a and 28b. In the base unit 22, the base chassis 27 is disposed on the bottom case 4 so that an end of the base unit 22 in the longitudinal direction is positioned at an approximately central position of the housing 3. On the end of the base unit 22 in the longitudinal, there are provided a disc mount 23 on which the optical disc 2 inserted into the housing 3 through the disc slot 19 is mounted and a disc rotation driving mechanism 24 that rotates the optical disc 2 mounted on the disc mount 23. Moreover, in the base unit 22, there are provided an optical pickup 25 that records or reproduces signals on or from the optical disc 2 being rotated by the disc rotation driving mechanism 24 and a pickup transferring mechanism 26 that conveys a pickup base 34 having the optical pickup 25 mounted thereon in a longitudinal direction so as to transfer the optical disc 2 in a radial direction of the optical disc 2. The optical pickup 25 and the pickup transferring mechanism 26 are mounted integrally on the base chassis 27. The base unit 22 moves upward and downward with respect to the optical disc 2 when the base chassis 27 is moved by a base lifting mechanism 150 to be described later.

The base unit 22 is moved toward the disc conveying area through the base opening 6c of the main chassis 6 so that the disc mount 23 is positioned at an approximately central position of the bottom portion of the bottom case 4. The base unit 22 can be moved upward and downward by the base lifting mechanism 150. In an initial state, the base unit 22 is positioned at a position lower than the optical disc 2 inserted into the housing 3 through the disc slot 19. When the optical disc 2 is loaded into the disc slot 19, the base unit 22 moves upward and engages with the optical disc 2 so that the optical disc 2 is rotated. Meanwhile, when a recording or reproducing operation is completed, the base unit 22 is moved downward by the base lifting mechanism 150, released from the engagement with the optical disc 2, and retracted from the conveying area of the optical disc 2.

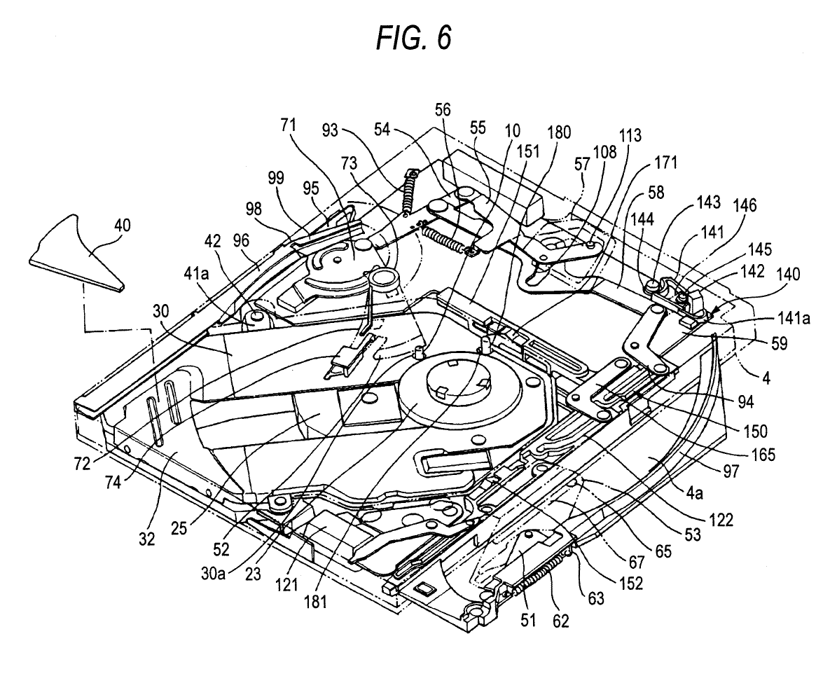

The base chassis 27 is formed by punching a metal plate into a predetermined shape and bending the peripheral portion of the punched metal plate a little downward. A turntable opening 27a having an approximately semi-circular shape through which the turntable 23a of the disc mount 23 is exposed upward and a pickup opening 27b having an approximately rectangular shape through which an objective lens 25a of the optical pickup 25 is exposed upward are formed contiguously to each other on a main surface of the base chassis 27. As shown in FIG. 6, a decorative plate 30 having openings corresponding to the openings 27a and 27b formed thereon is attached to the upper surface of the base chassis 27.

A guide plate 32 that prevents the base chassis 27 from making contact with the optical disc 2 and guides the optical disc 2 toward the abutment member 74 of the eject arm 52 is formed on an end of the base chassis 27 opposite to the disc mount 23 (see FIG. 6 for reference). Since a fabric sheet 40 is attached on the guide plate 32, it is possible to prevent the signal recording surface of the optical disc 2 from being damaged when the optical disc 2 collides into the guide plate 32.

Connecting parts 41a and 41b connected to the bottom case 4 through the dampers 28a and 28b are formed on both sides of the base chassis 27 in the longitudinal direction. The connecting parts 41a and 41b are provided with cutout portions 43 to which the dampers 28a and 28b are attached to be connect with the bottom case 4.

As shown in FIG. 8, the base chassis 27 includes a first spindle 47 disposed at the side of the disc mount 23 facing the slider 122 so as to engage with a first cam slit 130 of the slider 122, a second spindle 48 disposed at the side of the disc mount 23 facing a sub slider 151 so as to engage with a second cam slit 170 of the sub slider 151, and a third spindle 49 disposed at an opposite side of the side of the disc mount 23 facing the slider 122 so as to be pivotably supported on a spindle hole 9 (see FIG. 4 for reference) provided on the side plate 6b of the main chassis 6.

Therefore, in the base chassis 27, when the first spindle 47 slides within the first cam slit 130 and the second spindle 48 slides within the second cam slit 170 in accordance with the sliding movement of the slider 122 and the sub slider 151, the disc mount 23 is freely pivotable about the third spindle 49, thereby moving the base chassis 27 upward and downward.

As shown in FIG. 3, a support pin 10 that prevents excessive bending of the eject arm 52 when pivoted toward the disc mount 23 is erected on the bottom portion of the bottom case 4. The support pin 10 serves to prevent the optical disc 2 from colliding with the disc mount 23 and being damaged as the eject arm 52 is excessively bent downward. The support pin 10 is disposed in the vicinity of the disc mount 23 of the base unit 22 and protruded upward from the bottom portion of the bottom case 4 so that the support pin 10 passes through a hole 27c formed on the base chassis 27 and a hole 30a formed on the decorative plate 30 so as to be extended toward the disc conveying area.

The disc mount 23 includes the turntable 23a that is rotated by the disc rotation driving mechanism 24, and a chucking mechanism 33 for mounting the optical disc 2 on the turntable 23a is provided at a central portion of the turntable 23a. The chucking mechanism 33 includes an engagement protrusion 33a that engages with the central hole 2a of the optical disc 2 and a plurality of engagement hooks 33b that engage with the peripheral portion of the central hole 2 of the optical disc 2a engaging with the engagement protrusion 33a. The chucking mechanism 33 serves to hold the optical disc 2 on the turntable 23a.

The disc rotation driving mechanism 24 includes a spindle motor 24a having a flat shape that rotates the optical disc 2 integrally with the turntable 23a. The turntable 23 provided on the top surface of the spindle motor 24a is fixed with screws to the bottom surface of the base chassis 27 through a support plate 24b so that the turntable 23a is slightly protruded from the table opening 27a of the base chassis 27.

The optical pickup 25 has an optical block in which a light beam emitted from a semiconductor laser as a light source is focused by an objective lens 25a onto a signal recording surface of the optical disc 2 and a return light beam reflected from the signal recording surface of the optical disc 2 is detected by an optical detector constituted by a photo-sensor and the like. Thus, the optical pickup 25 records or reproduces signals on or from the optical disc 2.

Moreover, the optical pickup 25 includes an objective lens driving mechanism such as a biaxial actuator that moves the objective lens 25a in an optical axis direction (i.e., a focusing direction) of the objective lens 25a and in a direction perpendicular to a recording track of the optical disc 2 (i.e., a tracking direction). Thus, the optical pickup 25 is configured to perform a drive control operation such as a focus servo control for aligning the focal point of the objective lens 25a on the signal recording surface of the optical disc 2 and a tracking servo control for controlling the light beam spot focused by the objective lens 25a to follow the recording track, while controlling the biaxial actuator to move the objective lens 25a in the focusing and tracking directions on the basis of a detection signal from the optical disc 2 detected by the optical detector. As the objective lens driving mechanism, a tri-axial actuator which can perform a skew adjusting control as well as the focusing control and the tracking control may be used. The tri-axial actuator can adjust the angle (skew) of the objective lens 25a with respect to the signal recording surface of the optical disc 2 so that the light beam focused by the objective lens 25a is vertically incident on the signal recording surface of the optical disc 2.

The pickup transferring mechanism 26 is configured to include the pickup base 34 having the optical pickup 25 mounted thereon, a pair of guide shaft 35a and 35b slidably supporting the pickup base 34 in the radial direction of the optical disc 2, and a movement driving mechanism 36 moving the pickup base 34 supported by the guide shaft 35a and 35b in the radial direction of the optical disc 2.

On the pickup base 34, there are formed a pair of guide parts 37a and 37b having guide holes formed therein through which the guide shaft 35a extends and a guide part 38 having a guide groove formed therein with the guide shaft 35b disposed therebetween. The guide shafts 37a and 37b and the guide part 38 are protruded from the lateral sides facing each other. Thus, the pickup base 34 is slidably supported by the guide shafts 35a and 35b.

The guide shafts 35a and 35b are disposed on the bottom surface of the base chassis 27 in parallel with the radial direction of the optical disc 2 and guide the pickup base 34, where the optical pickup 25 is exposed through the opening 27b of the base chassis 27, between the inner and outer circumference of the optical disc 2.

As shown in FIGS. 8 to 10, the movement driving mechanism 36 includes the lead screw 201 extending along the diameter direction of the optical disc 2 in parallel with the guide shaft 35a, a drive motor 31 disposed on the side of the third spindle 49 serving as a pivot point for the lifting operation of the base unit 22 so as to rotate the lead screw 201, and an engagement member 204 attached to the pickup base 34 and configured to receive the rotating force from the lead screw 201 and move the pickup base 34 between the inner and outer circumference of the optical disc 2. The movement driving mechanism 36 converts the rotation of the drive motor 31 into a linear movement through the lead screw 201 and moves the pickup base 34 along the guide shafts 35a and 35b, namely, in the radial direction of the optical disc 2.

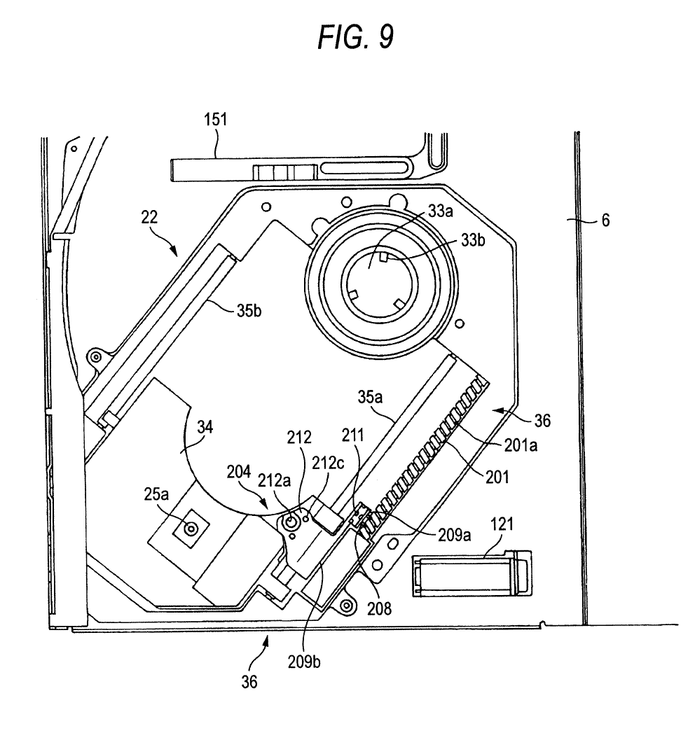

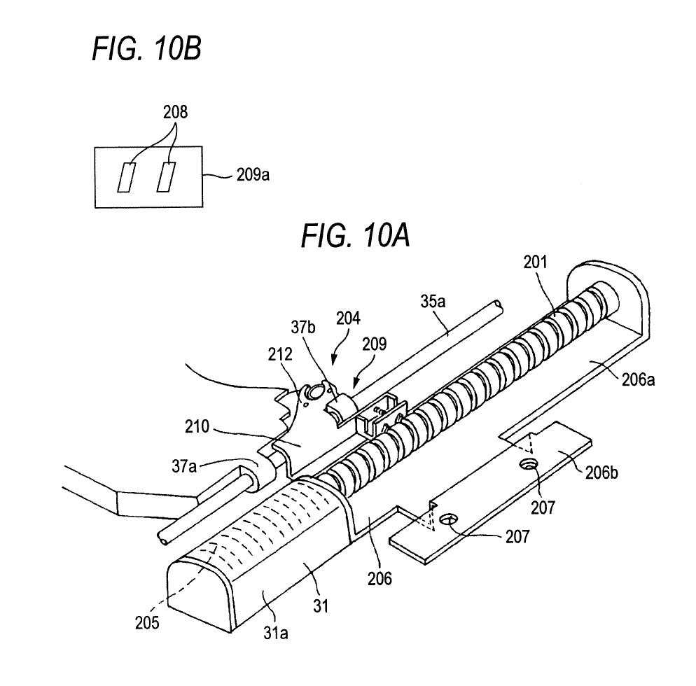

As shown in FIG. 10A, the lead screw 201 is rotatably supported by a bearing 202 disposed at a front end of a shaft 201a. As shown in FIG. 9, the lead screw 201 is installed on the bottom case 4 so that the axial line of the lead screw 201 is substantially parallel with the guide shaft 35a when taken in a plan view. A screw groove 203 is formed on the shaft 201a of the lead screw 201 so that the engagement member 204 provided on the pickup base 34 slidably engages with the screw grooves 203. When the lead screw 201 is rotated by the drive motor 31, the pickup base 34 is moved in the diameter direction of the optical disc 2 through the engagement member 204.

The drive motor 31 that rotates the lead screw 201 is constituted by a stepping motor. When a magnetic core of the drive motor 31 is transferred step-wise by a rectangular wave, the lead screw 201 is rotated and the pickup base 34 is moved in the diameter direction of the optical disc 2. Therefore, it is possible to reduce noise compared with the case where a DC motor is used as the drive motor 31 that rotates the lead screw 201 and the drive motor 31 is connected to the lead screw 201 by a gear mechanism.

In other words, the drive motor 31 is constituted by the stepping motor, and the pickup base 34 is transferred step-wise in the diameter direction of the optical disc 2 by the rectangular wave.

As shown in FIG. 10A, the drive motor 31 includes a motor housing 31a in which a coil 205 is received.

The drive motor 31 and the lead screw 201 are attached to the base chassis 27 through a frame 206. The frame 206 includes a connection portion 206a having an approximately rectangular shape to which the bearing 202 for supporting the lateral side where the lead screw 201 of the motor housing 31a is protruded and the front end of the lead screw 201 are connected, and an attachment portion 206b formed continuously with the connection portion 206a and having a screw hole 207 formed therein through which a screw to be attached to the base chassis 27 is inserted. The attachment portion 206b is protruded from the connection portion 206a so that the attachment portion 206b is fixed with screws to the rear surface of the base chassis 27.

As shown in FIGS. 8 to 10A, the engagement member 204 engaging with the screw grooves 203 formed in the lead screw 201 has one end thereof fixed with screws to the pickup base 34 and the other end thereof engaging with the screw grooves 203 of the lead screw 201. That is, the engagement member 204 constitutes a rack that converts the rotation of the lead screw 201 into the linear movement.

The engagement member 204 includes a pair of engagement protrusions 208, 208 engaging with the screw grooves 203 of the lead screw 201 and a recess portion 209 receiving a spring 210 that presses the engagement protrusions 208 toward the screw grooves 203 so that the engagement between the engagement protrusions 208 and the lead screw 201 is maintained.

The engagement protrusions 208 are formed on a wall 209a disposed on the side of the lead screw 201 of the recess portion 209 so as to protrude toward the lead screw 201. As shown in FIG. 10B, the engagement protrusions 208 are formed with the same inclination as the screw grooves 203 of the lead screw 201 and have substantially the same width as the screw grooves 203. The engagement protrusions 208, 208 are separated from each other with the same gap as the screw grooves 203.

The recess portion 209 having the engagement protrusions 208 formed thereon is a generally U-shaped concave portion opened to the upper side thereof. In the recess portion 209, locking protrusions 211, 211 are formed on the respective inner sidewalls of the wall 209a on the side of the lead screw 201 and the wall 209b on the side of the guide shaft 35a. The spring 210 is fitted to the locking protrusions 211 so as to prevent the slippage of the locking protrusions 211 from the recess portion 209. The wall 209b on the side of the guide shaft 35a of the recess portion 209 extends along the axial line of the guide shaft 35a so that the screw grooves 203 of the lead screw 201 engages with the engagement protrusions 208, while bypassing the drive motor 31 formed on the side of the third spindle 49 disposed on an opposite side of the disc mount 23.

A connected surface portion 212 for connecting the engagement member 204 to the pickup base 34 is formed on an upper side of the wall 209b on the side of the guide shaft 35a. The connected surface portion 212 passes through the upper side of the guide shaft 35a disposed between the lead screw 201 and the pickup base 34 and extends to the top surface of the pickup base 34 so as to be fixed with screws to the top surface of the pickup base 34. Specifically, the connected surface portion 212 includes a through-hole 212a connected to the screw hole 33a of the pickup base 34 and engagement holes 212b and 212c engaging with engagement protrusions 34b and 34c disposed on the pickup base 34 in the vicinity of the through-hole 212a so as to be fitted to the pickup base 34 of the engagement member 204.

In the movement driving mechanism 36 of the pickup transferring mechanism 26 having such an arrangement, a unit having the lead screw 201 and the drive motor 31 attached to the frame 206 shown in FIG. 10A is fixed with screws to the corresponding parts of the base chassis 27, and the rotation of the lead screw 201 is converted into the linear movement through the engagement member 204. Accordingly, it is possible to move the pickup base 34 in the radial direction of the optical disc 2.

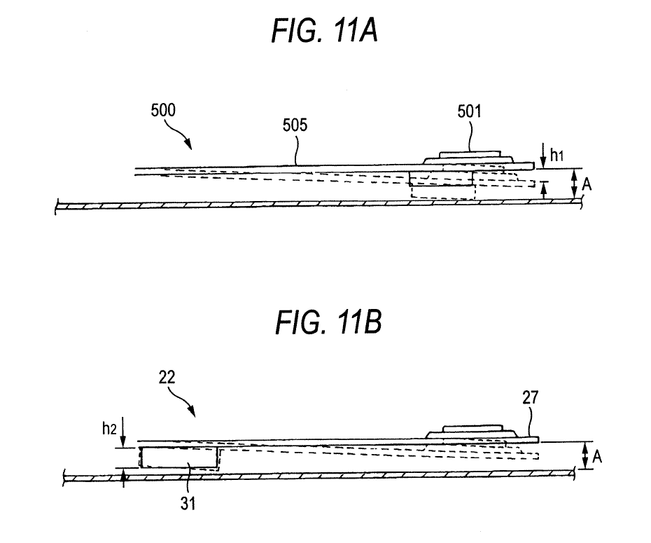

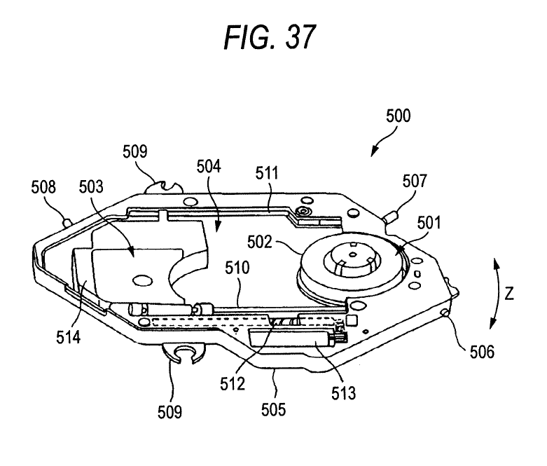

In the pickup transferring mechanism 26, since the drive motor 31 is disposed at an opposite side of the disc mount 23 and provided on the side of the third spindle 49 serving as a pivot point for the lifting operation of the base unit 22, it is possible to decrease the movement of the base unit 27 by the base lifting operation and use a large-sized drive motor compared with the known base unit in which the drive motor 31 is provided to the side of the disc mount 23. Specifically, in the base unit 500 of the known disc drive (see FIG. 37 for reference), the clearance required for lifting the base unit 500 is depicted in FIG. 11A as A with the height h₁ of the drive motor 513. Meanwhile, as shown in FIG. 11B, in the base unit 22 of the disc drive 1 according to the embodiment of the invention, when the clearance required for lifting the base unit 22 is set to A, it is possible to use the drive motor 31 having a height h₂(>h₁). Since the drive motor 31 is provided in the vicinity of the pivot point for lifting the base unit 22, the movement due to the lifting operation is decreased compared to the known disc drive in which the drive motor is provided apart from the pivot point. Therefore, it is possible to use a large-sized drive motor capable of operating at a high speed and manufacture the entire apparatus in a slimmer profile.

In the base unit 22 having such an arrangement, since the drive motor 31 of the pickup transferring mechanism 26 is fixed to the side of the third spindle 49 serving as a pivot point of the base chassis 27, the load of the base chassis 27 is not concentrated in the vicinity of the disc mount 23, thereby decreasing the moment required for lifting the base unit 22 and decreasing a burden on the drive motor 121 that drives the base lifting mechanism 150.

The pickup transferring mechanism 26 is not limited to the slot-in type disc drive 1 but may be used in a tray type disc drive so far as it can lift the base unit 22.

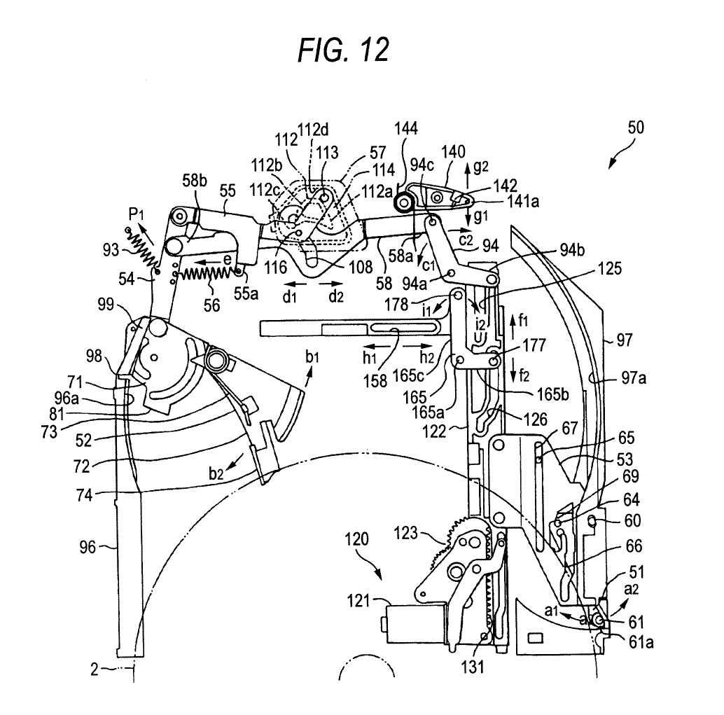

As shown in FIGS. 12 to 19, the disc drive 1 has a disc conveying mechanism 50 that conveys the optical disc 2 between a disc insertion and ejecting position where the optical disc 2 is inserted or ejected into or from the disc slot 19 and a disc mount position where the optical disc 2 is mounted on the turntable 23a of the disc mount 23.

The disc conveying mechanism 50 is a support member that moves between the top surface 6a of the main chassis 6 and the main surface of the top plate 5a facing the disc mount 23. The disc conveying mechanism 50 includes the loading arm 51 and the eject arm 52 that can freely pivot in a plane parallel to the main surface of the optical disc 2, the loading cam plate 53 that transfers the driving force from the driving mechanism 120 to the loading arm 51, the first link arm 54 that moves the eject arm 52 in the ejecting direction of the optical disc 2, the second link arm 55 connected to the first link arm 54, an tension coil spring 56 extending between the first and second link arms 54 and 55, the loop cam 57 that engages with the guide protrusion 113 of the second link arm 55 so as to guide the second link arm 55, and the actuating arm 58 that is connected to the driving mechanism 120 so as to actuate the first link arm 54 so that the eject arm 52 moves the optical disc 2 to the inserting or ejecting direction of the optical disc 2.

In the disc conveying mechanism 50, when the eject arm 52 pivots to a predetermined position as the optical disc 2 is inserted, the first link arm 54 is pivoted in a predetermined direction by the eject arm 52. When the guide protrusion 113 formed at the front end is guided by the loop cam 57, the second link arm 55 is pivoted in a direction opposite to the predetermined pivot direction of the first link arm 54, whereby the second link arm 55 is pivoted toward the inserting direction while the eject arm 52 is biased by the tension coil spring 56 toward the ejecting direction. Meanwhile, when the optical disc 2 is ejected, the guide protrusion 113 of the second link arm 55 is guided by the loop cam 57 and the first and second link arms 54 and 55 approach toward each other. As a result, the actuating arm 58 actuates the first link arm 54 so that the eject arm 52 is pivoted by the first link arm 54 in a state that the tension coil spring 56 is not extended and a biasing force is not applied in the ejecting direction, thereby ejecting the optical disc 2.

Therefore, since the biasing force of the tension coil spring 56 is applied in the ejecting direction in the course of a user's pushing the optical disc 2 to a predetermined position at the time of insertion of the optical disc 2, it is possible to prevent the optical disc 2 from being left in a state where it is partly inserted into the housing 3 due to the user's stopping the inserting of the optical disc 2. Moreover, since the biasing force of the tension coil spring 56 that was applied to the eject arm 52 is not applied in the ejecting direction at the time of ejecting the optical disc 2 from the housing 3, the eject arm 52 is pivoted with the actuation of the actuating arm 58 to which the driving force of the driving mechanism 120 is applied. Accordingly, it is possible to stably eject the optical disc 2 to a predetermined stop position at which the central hole 2a of the optical disc 2 is located outside the housing 3 without relying on the elastic force.

Hereinafter, components of the disc conveying mechanism 50 will be described.

The loading arm 51 moves the optical disc 2 so as to be mounted on the disc mount 23 and includes a base end pivotably supported on the deck portion 4a of the bottom case 4 so as to be disposed closer to the disc slot 19 than the disc mount 23 and a free end pivoting in directions indicated by arrows a₁ and a₂ in FIG. 12. Specifically, the loading arm 51 is made of a flat metal plate and an insertion portion 60 is protruded from an end portion of the loading arm 51 to engage with the deck portion 4a, whereby the loading arm 51 can pivot along the a₁ and a₂ direction in FIG. 12 over the deck portion 4a.

An abutment 61 abutting the periphery of the optical disc 2 inserted through the disc slot 19 is protruded upward from the free end of the loading arm 51. A rotating roller 61a having a small diameter is rotatably attached to the abutment 61. The abutment 61 is a drum-like flange made of a resin more flexible than the optical disc 2 in which the central portion of the abutment 61 that abuts the periphery of the optical disc 2 inserted through the disc slot 19 is bent toward the inner side and the diameter of both side portions is greater that of the central portion. The abutment 61 serves to restrict the height directional movement of the optical disc 2.

A locking part 63 is protruded from the loading arm 51 in the vicinity of the insertion portion 60, and an end of the coil spring 62 having the other end thereof fixed to the right-side guide wall 97 is fitted to the locking part 63 (see FIG. 6 for reference). As a result, the loading arm 51 is always biased about the insertion portion 60 by the biasing force of the coil spring 62 so as to be pivoted in the a₁ direction in FIG. 12 where the optical disc 2 is biased toward the disc mount 23 from the disc slot 19.

An engagement protrusion 64 that insertedly engages with a first cam groove 66 of the loading cam plate 53, which will be described later, is protruded from the loading arm 51. Since the engagement protrusion 64 moves along the first cam groove 66 of the loading cam plate 53, the loading arm 51 is pivoted while restricting the biasing force of the coil spring 62.

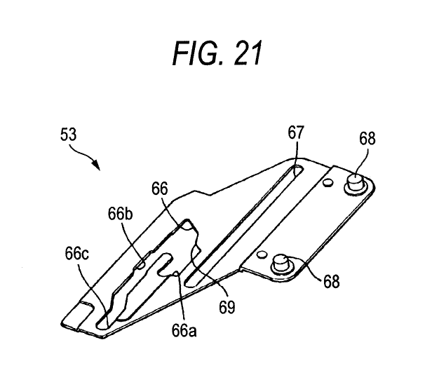

The loading cam plate 53 on which the loading arm 51 is pivoted is made of a flat metal plate and engages with the slider 122 of the driving mechanism 120 so that the loading arm 51 is moved forward and backward on the deck portion 4a in accordance with the movement of the slider 122. The loading cam plate 53 is placed on the loading arm 51 mounted on the deck portion 4a, and the engagement protrusion 64 is inserted into the loading cam plate 53, thereby restricting the pivot movement of the loading arm 51. As shown in FIG. 21, the loading cam plate 53 includes a first cam groove 66 into which the engagement protrusion 64 protruded from the loading arm 51 is inserted, a second cam groove 67 into which the guide protrusion 65 protruded from the deck portion 4a, and a pair of engagement protrusions 68, 68 engaging with the slider 122.

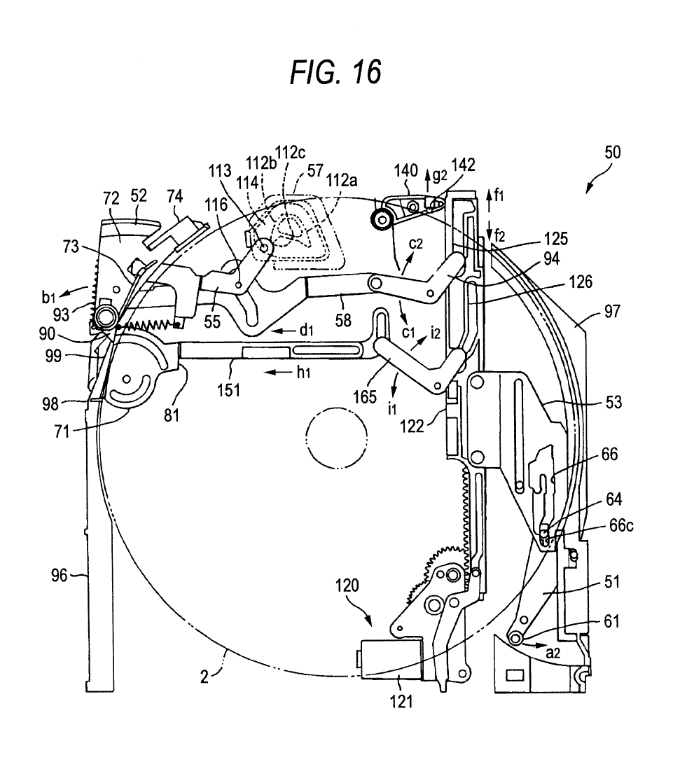

The first cam groove 66 restricts the pivot movement of the loading arm 51 that is biased in the loading direction of the optical disc 2 by the coil spring 62 with the sliding movement of the engagement protrusion 64. The first cam groove 66 includes a first guide portion 66a restricting the engagement protrusion 64 so as to restrict the pivot movement of the loading arm 51 in the a₁ direction in FIG. 12, i.e., the loading direction of the optical disc 2, a second guide portion 66b disposed close to and continuously with the first guide portion 66a so as to pivot the loading arm 51 in the loading direction of the optical disc 2, and a third guide portion 66c disposed continuously with the second guide portion 66b to guide the engagement protrusion 64 so that the loading arm 51 is pivoted in the a₂ direction in FIG. 16 where the loading arm 51 is disposed apart from the periphery of the optical disc 2 mounted on the disc mount 23.

When the loading cam plate 53 is moved backward in the housing 3, the engagement protrusion 64 moves along the second guide portion 66b and the loading arm 51 to which the biasing force of the coil spring 62 is applied is pivoted in the a₁ direction in FIG. 12, i.e., the loading direction of the optical disc 2, thereby pressing the optical disc 2 onto the disc mount 23. When the optical disc 2 is mounted on the disc mount 23, the engagement protrusion 64 moves along the third guide portion 66c and the loading arm 51 is pivoted in the a₂ direction in FIG. 16 by the biasing force of the coil spring 62, whereby the abutment 61 of the loading arm 51 is separated from the optical disc 2 and the optical disc 2 can be rotated.

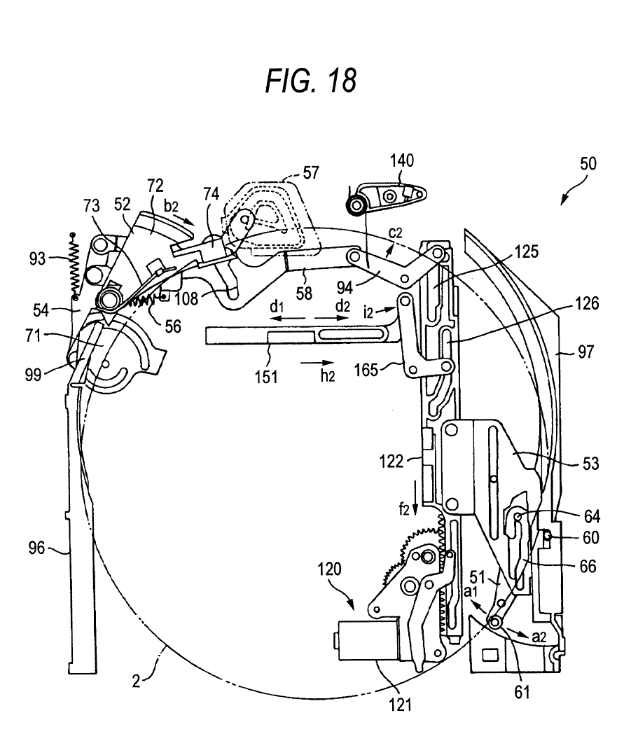

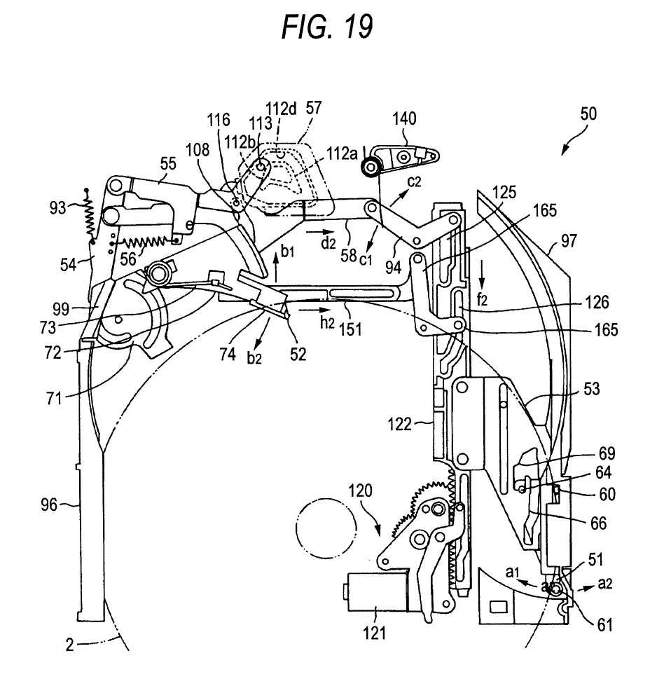

When the optical disc 2 is ejected, the loading cam plate 53 is moved backward with the forward movement of the slider 122. Accordingly, the engagement protrusion 64 is moved from the second guide portion 66b to the first guide portion 66a, and the loading arm 51 is pivoted in the a₁ direction in FIGS. 18 and 19 so as to be in contact with the optical disc 2. In this case, the optical disc 2 is pressed in the ejecting direction by the eject arm 52 to which the driving force of the driving mechanism 120 is applied so that the optical disc 2 is ejected while being biased in the inserting direction by the loading arm 51 biased by the coil spring 62. With this arrangement, in the disc conveying mechanism 50, since the optical disc 2 is moved to a predetermined eject position while being pressingly sandwiched between the loading arm 51 and the eject arm 52 at the time of ejecting the optical disc 2, the loading arm 51 prevents abrupt jumping of the optical disc 2.

When the ejecting of the optical disc 2 is completed, the engagement protrusion 64 is fitted to a protrusion 69 formed in the first cam groove 66 of the loading cam plate 53, whereby the pivot movement of the loading arm 51 in the a₁ direction is restricted, and the loading arm 51 is maintained at a position retracted from the disc conveying area. In this state, the insertion of the optical disc 2 is waited for.

The second cam groove 67 guides the movement of the loading cam plate 53 as the guide protrusion 65 protruded from the deck portion 4a is insertedly moved along the second cam groove. The second cam groove 67 is a linear cam groove parallel to the moving direction of the slider 122 and guides the loading cam plate 53 in the moving direction of the slider 122 as the guide protrusion 65 slidingly moves with the movement of the slider 122.

The engagement protrusions 68, 68 engaging with the slider 122 is separated from each other on one lateral surface of the loading cam plate 53. The engagement protrusions 68, 68 are protruded downward and projected from the bottom portion of the bottom case 4 so as to engage with engagement concave portions 127, 127 of the slider 122 provided along the side of the bottom case 4. With this arrangement, the loading cam plate 53 and the slider 122 is combined as a single body and thus the loading cam plate 53 slides with the movement of the slider 122.

In the loading cam plate 53, the one side surface having the engagement protrusions 68, 68 formed thereon and the other surface slidably passes through the clearance area disposed between the right-side guide wall 97 and the deck portion 4a, thereby preventing floating from the deck portion 4a.

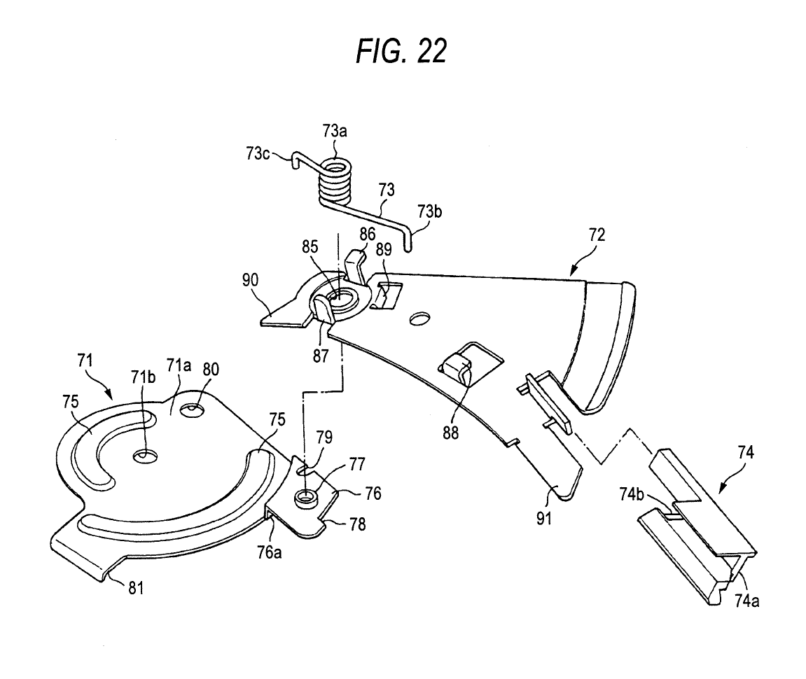

The eject arm 52 that ejects the optical disc 2 from the disc mount 23 to the outside of the disc slot 19 is provided on the lateral surface opposite to the surface having the loading arm 51 formed thereon so as to be disposed closer to the bottom surface of the housing 3 than the disc mount 23. The eject arm 52 is actuated by the first and second link arms 54 and 55 and the actuating arm 58 so as to be pivoted in the b₁ direction in FIG. 12 where the optical disc 2 is conveyed toward the disc mount 23 and in the b₂ direction in FIG. 12 where the optical disc 2 is ejected toward the disc slot 19. As shown in FIG. 22, the eject arm 52 includes a pivot support member 71 pivotably supported on the main chassis 6, a compress arm 72 pivotably engaged with the pivot support member 71 so as to press the optical disc 2, a coil spring 73 biasing the compress arm 72 in the ejecting direction of the optical disc 2, and an abutment member 74 attached to the free end of the compress arm 72 so as to be in contact with the side surface of the optical disc 2.

The pivot support member 71 is made of a metal plate having an approximately circular shape and is rotatably attached to the top surface 6a of the main chassis 6 opposite to the disc conveying area. An attachment hole 71b for attachment to the main chassis 6 is pored into an approximately central portion of the main surface 71a of the pivot support member 71. A protruded slide contact portion 75 that slidingly makes contact with the main chassis 6 is swelled on the main surface 71a of the pivot support member 71. The pivot support member 71 is smoothly rotated as the slide contact portion 75 slidingly makes contact with the main chassis 6.

An engagement part 76 engaging with the compress arm 72 and the coil spring 73 is formed on the pivot support member 71. The engagement part 76 is bent from a distal end of an erected wall 76a that is erected from the main surface 71a so that the engagement part 76 is disposed above the main surface 71a and protruded more toward the top surface 6a than the eject arm opening 6d of the main chassis 6. The engagement part 76 includes a cylindrical engagement portion 77 which is inserted through the opening 85 of the compress arm 72 and into which the coil spring 73 is inserted, a pivot restricting portion 78 engaging with the locking part 89 protruded from the compress arm 72 and restricting the pivot movement of the compress arm 72, and a locking concave portion 79 fitted to an arm 73c of the coil spring 73.

An engagement hole 80 rotatably engaging with the first link arm 54 is formed on the main surface 71a of the pivot support member 71. A bent part 81 is bent from one side surface of the main surface 71a of the pivot support member 71. The bent part 81 is bent downward from the main surface 71a and serves as a colliding part that collides with a sub slider 151 of the base lifting mechanism 150. When the optical disc 2 is inserted, the bent part 81 is pivoted in the b₁ direction in FIG. 12 where the optical disc 2 is conveyed toward the disc mount 23, whereby a first switch SW1 installed in the circuit board 59 is turned on. With this arrangement, it is possible in the disc drive 1 to determine whether the eject arm 52 pressed by the optical disc 2 is pivoted to the back side of the housing 2. Accordingly, it is possible to determine the timing for driving the driving mechanism 120.

The compress arm 72 rotatably engaging with the engagement part 76 is made of a flat metal plate and includes an opening 85 disposed at an end of the compress arm 72 so as to insertedly engage with the engagement portion 77 of the engagement part 76, first to third engagement protrusions 86 to 88 fitted to the coil spring 73, a locking part 89 fitted to the pivot restricting portion 78 of the pivot support member 71, a pressing part 90 pressing the left-side guide wall 96 guiding the centering of the optical disc 2 so as to separate the left-side guide wall 96 from the optical disc 2, and an attachment portion 91 disposed at the other end and attached to the abutment member 74. When the engagement portion 77 of the pivot support member 71 is inserted through the opening 85, the compress arm 72 pivotably engages with the pivot support member 71. The first and second locking protrusions 86 and 87 erected from the periphery of the opening 85 are inserted through a cylindrical portion 73a of the coil spring 73 so as to retain the coil spring 73 therebetween. The third locking protrusion 88 is fitted to one arm 73b of the coil spring 73. The other arm 73c of the coil spring 73 is fitted to the locking concave portion 79 of the pivot support member 71. As a result, the compress arm 72 is pivotably biased toward the disc slot 19 about the engagement portion 77 of the pivot support member 71 by a certain spring force.

The locking part 89 is bent downward from the vicinity of the opening 85 and makes contact with the pivot restricting portion 78 of the pivot support member 71 in accordance with the pivot movement of the compress arm 72, thereby restricting the pivot movement of the compress arm 72 that is biased toward the disc slot 19. The pressing part 90 presses the left-side guide wall 96 that guides the centering of the optical disc 2 biased toward the conveying area of the optical disc 2 so that the left-side guide wall 96 is retracted from the optical disc 2 at the time of recording and/or reproducing, thereby making it possible to rotate the optical disc 2.

The abutment member 74 attached to the attachment portion 91 of the compress arm 72 is made of a resin-made material flexible than the optical disc 2 and includes a concave disc receiving portion 74a making contact with the periphery of the optical disc 2, an insertion hole 74b through which the attachment portion 91 of the compress arm 72 is inserted, and a restricting portion 74c restricting an erroneous insertion of a small-diameter disc into the housing 3. The abutment member 74 is combined with the compress arm 72 by inserting the attachment portion 91 into the insertion hole 74b. A stopper 100 for preventing the erroneous insertion of the small-diameter optical disc 101 may be formed in the abutment member 74. Details of the stopper 100 will be described later.

In the eject arm 52, the pivot support member 71 is pivotably engaged with the compress arm 72, and the compress arm 72 is pivotably biased toward the disc slot 19 by the spring force of the coil spring 73. When the eject arm 52 is pivoted in the b₂ direction in FIG. 19 where the optical disc 2 is ejected out from the housing 3 by the first link arm 54 and the actuating arm 58 applied with the driving force of the driving mechanism 120 and a force in the b₁ direction is applied to the eject arm 52 due to the presence of an obstacle disposed on the conveying area of the optical disc 2, the compress arm 72 applied with a force opposite to the ejecting direction of the optical disc 2 is pivoted in the b₁ direction about the engagement portion 77 of the pivot support member 71 against the biasing force of the coil spring 73. With this arrangement, it is possible to the driving force for pivoting the eject arm 52 in the b₂ direction from confronting with the force applied in a direction opposite to the driving force. Accordingly, excessive loads are not applied to the motor of the driving mechanism 120 that drives the first link arm 54 and the actuating arm 58 so that the eject arm 52 is pivoted in the b₂ direction in FIG. 19. Moreover, it is possible to prevent the destruction of the optical disc 2 by being sandwiched between the biasing force applied in the ejecting direction by the eject arm 52 and the counter-directional force.

The first link arm 54 pivotably engaging with the pivot support member 71 of the eject arm 52 is actuated by the actuating arm 58 such that the eject arm 52 is pivoted in the b₁ or b₂ direction in FIG. 12, i.e., the insertion or ejecting direction of the optical disc 2. The first link arm 54 is made of a metal plate having an approximately rectangular shape and includes one end in the longitudinal direction rotatably engaging with the engagement hole 80 of the pivot support member 71 and the other end rotatably engaging with the second link arm 55. One end of a biasing coil spring 93, an end 58b of the actuating arm 58, and an end of the tension coil spring 56 extending over the second link arm 55 are attached to the middle portion of the first link arm 54 in the longitudinal direction.

The biasing coil spring 93 has the other end fitted to the locking portion provided on the top surface 6a of the main chassis 6 and the one end attached to the middle portion of the first link arm 54. By this arrangement, the biasing coil spring 93 raises the first and second link arm 54 and 55 in the P₁ direction in FIG. 12 so that the guide protrusion 113 of the second link arm 55 is circulated in the loop cam 57.

The second link arm 55 rotatably engaging with the other end of the first link arm 54 is made of an elongated metal plate, and the guide protrusion 113 is protruded toward the guide groove 114 of the loop cam 57 from an end of the second link arm 55. The guide protrusion 113 is engaged with the guide groove 114 and guided by a loading guide wall 112a and an eject guide wall 112b, thereby controlling the distance between the first link arm 54 and the second link arm 55. A spring locking part 55a is provided in the middle portion of the longitudinal direction of the second link arm 55, and one end of the tension coil spring 56 extending between the first link arm 54 and the second link arm 55 is fitted to the spring locking part 55a.

An engagement protrusion 116 engaging with a cam groove 108 formed on the actuating arm 58 is formed on the second link arm 55. In the disc conveying mechanism 50, when the engagement protrusion 116 engages with the cam groove 108, the eject arm 52 is pivoted with the movement of the slider 122, whereby the second link arm 55 stably ejects the optical disc 2 to a predetermined ejecting position.

That is, when the panel curtain provided in the disc slot 19 of the front panel 18 slidingly makes contact with the optical disc 2 in the course of ejecting the optical disc 2, loads are applied to the eject arm 52 so that the pivot support member 71 of the eject arm 52 and the first link arm 54 are biased in the b₁ direction. In this case, when the second link arm 55 is not engaged with the actuating arm 58 and the first link arm 54 is moved in the d₂ direction in accordance with the sliding movement of the slider 122 in the f₂ direction, the first link arm 54 cannot pivot the eject arm 52 in the b₂ direction only by rotating the actuating arm 58 in the d₂ direction about the engagement hole 80 with respect to the pivot support member 71. Moreover, the second link arm 55 is only pivoted with respect to the first link arm 54.

When the second link arm 55 is engaged with the actuating arm 58, the engagement protrusion 116 makes contact with the lateral wall of the cam groove 108 in accordance with the sliding movement of the actuating arm 58 in the d₂ direction. Accordingly, the second link arm 55 cannot be freely pivoted with respect to the first link arm 54. That is, the rotation of the first link arm 54 in the d₂ direction is restricted when the engagement protrusion 116 of the second link arm 55 is disconnected from the lateral wall of the cam groove 108. Accordingly, when the eject arm 52 is biased toward the b₁ direction in the course of ejecting the optical disc 2 and the actuating arm 58 is moved in the d₂ direction, the first link arm 54 is moved in the d₂ direction against the biasing force in the b₁ direction so as to pivot the eject arm 52 in the b₂ direction. As a result, the eject arm 52 is pivoted in the b₂ direction by the sliding amount of the slider 122 in the f₂ direction, thereby making it possible to securely eject the optical disc 2 to a predetermined ejecting position.

The loop cam 57 that guides the movement of the guide protrusion 113 of the second link arm 55 engages with the locking hole pored into the top surface 6a of the main chassis 6, and a cam wall 112 having an approximately circular shape is erected toward the bottom case 4. The guide protrusion 113 of the second link arm 55 circulates in the cam wall 112 in the course of the loading and ejecting the optical disc 2 and includes a loading guide wall 112a on which the guide protrusion 113 slides at the time of loading the optical disc 2, an eject guide wall 112b on which the guide protrusion 113 slides at the time of ejecting the optical disc 2, a protrusion 112c for preventing a reverse movement of the guide protrusion 113 between the loading guide wall 112a and the eject guide wall 112b, and a guide groove 114 formed by surrounding the eject guide wall 112b and the protrusion 112c by the peripheral portion 112d, in which the guide protrusion 113 moves.

The actuating arm 58 connected to the first link arm 54 and the driving mechanism 120 so as to actuate the eject arm 52 is made of an elongated metal plate, and the cam groove 108 through which the engagement protrusion 116 formed in the second link arm 55 is formed in the central portion of the actuating arm 58 in the longitudinal direction. The actuating arm 58 includes one end 58a in the longitudinal direction engaged with a third link arm 94 connected to the slider 122 of the driving mechanism 120 and the other end 58b engaged with the first link arm 54.

As described above, the cam groove 108 engages with the engagement protrusion 116 of the second link arm 55 so as to pivot the eject arm 52 in accordance with the sliding movement of the slider 122. The cam groove 108 has a long slot shape so that the engagement protrusion 116 can move as the second link arm 55 circulates in the loop cam 57. Moreover, the cam groove 108 is disposed in a direction approximately perpendicular to the d₁ and d₂ directions in FIG. 12, i.e., the movement direction of the actuating arm 58. With this arrangement, when the engagement protrusion 116 makes contact with the side wall, the cam groove 108 can restrict the pivot movement of the second link arm 55 and the rotation of the first link arm 54 in the d₂ direction.

By allowing the slider 122 to slide, the actuating arm 58 is moved in the d₁ and d₂ directions in FIG. 12 corresponding to left and right directions by the third link arm 94 so as to pivot the first link arm 54 and the eject arm 52. Specifically, when the actuating arm 58 is moved in the d₁ direction in FIG. 12 by the third link arm 94, the actuating arm 58 presses the first link arm 54 in the same direction, whereby the eject arm 52 is pivoted in the b₁ direction in FIG. 12, i.e., the inserting direction of the optical disc 2. Moreover, when the actuating arm 58 is moved in the d₂ direction in FIG. 12 by the third link arm 94, the actuating arm 58 presses the first link arm 54 in the same direction, whereby the eject arm 52 is pivoted in the b₂ direction in FIG. 12, i.e., the ejecting direction of the optical disc 2.

The third link arm 94 pivotably engaging with the one end 58a of the actuating arm 58 is made of an approximated C-shaped metal plate. Since a bent portion 94a of the third link arm 94 is pivotably attached to the main chassis 6, the third link arm 94 is pivotably supported in the c₁ and c₂ direction in FIG. 12, the engagement protrusion 109 formed in one end 94b extended from the bent portion 94a engages with the slider 122, and the other end 94c is rotatably engaged with the actuating arm 58. With this arrangement, when the slider 122 is conveyed in the f₁ direction in FIG. 12 in accordance with the application of the driving force of the drive motor 121 of the driving mechanism 120, the third link arm 94 is guided by the first guide groove 125 formed in the slider 122 so as to be pivoted in the c₁ direction in FIG. 12, thereby moving the actuating arm 58 in the d₁ direction in FIG. 12. Moreover, when the slider 122 is conveyed in the f₂ direction in FIG. 12, the third link arm 94 is guided by the first guide groove 125 so as to be pivoted in the c₂ direction in FIG. 12, thereby moving the actuating arm 58 in the d₂ direction in FIG. 12.

The left- and right-side guide walls 96 and 97 disposed on both side of the disc conveying area serve to guide the centering of the optical disc 2 while making contact with the lateral surface of the optical disc 2 and are made of a synthetic resin more flexible than the optical disc 2. The left- and right-side guide wall 96 and 97 are disposed on the main chassis 6 and the deck portion 4a, respectively, and both walls are fixed with screw, adhesive tapes or the like.

Sidewalls 96a and 97a having a circular arc shape corresponding to the shape of the optical disc 2 are erected from the left- and right-side guide walls 96 and 97. The sidewalls 96a and 97a are disposed at positions with a certain clearance from the lateral surface of the optical disc 2 conveyed to the centering position and do not make contact with the optical disc 2 being rotated. In the sidewall 96a of the left-side guide wall 96, the front end on the opposite side of the disc slot 19 constitutes a centering guide part 99 that can freely pivot through a hinge portion 98 over the disc conveying area. The centering guide part 99 is biased toward a planar spring 95 (see FIG. 6, for reference) so as to be bent toward the disc conveying area, thereby making contact with the side surface of the optical disc 2. With this arrangement, the optical disc 2 is biased by the centering guide part 99 in the centering direction. Moreover, when the optical disc 2 is inserted to the inner side of the housing 3 and the eject arm 52 is pivoted in the b₁ direction, the centering guide part 99 is pressed onto the pressing part 90 formed in the compress arm 72 so as to be retracted from the disc conveying area. Accordingly, the centering guide part 99 is maintained at a position separated from the side surface of the optical disc 2 in the recording and reproducing operations.

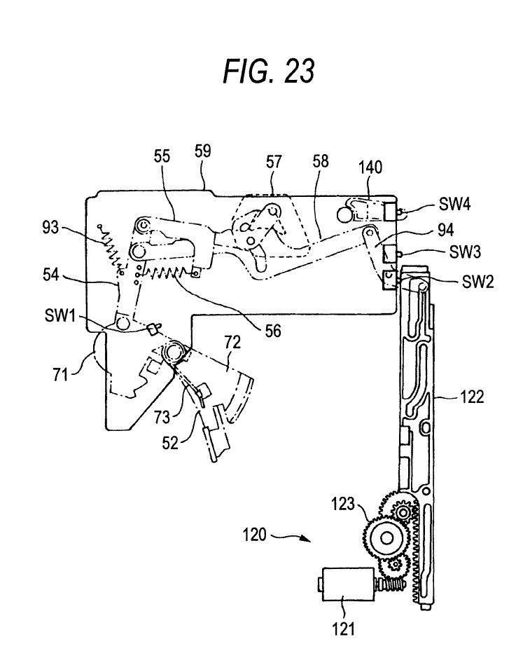

Next, operations of inserting and ejecting the optical disc 2 by the disc conveying mechanism 50 will be described. The conveying state of the optical disc 2 is monitored by detecting the press state of first to fourth switches SW1 to SW4 installed in the circuit board 59. As shown in FIG. 23, the first switch SW1 is disposed in the pivot area of the pivot support member 71 of the eject arm 52 and pressed onto the pivot support member 71 in accordance with the pivot movement of the eject arm 52, thereby changing the switch state into H/L. As shown in FIG. 23, the second to fourth switches SW2 to SW4 are arranged in the moving area of the slider 122, and the switch states are sequentially converted into H/L in accordance with the sliding movement of the slider 122 in the f₁ or f₂ direction.

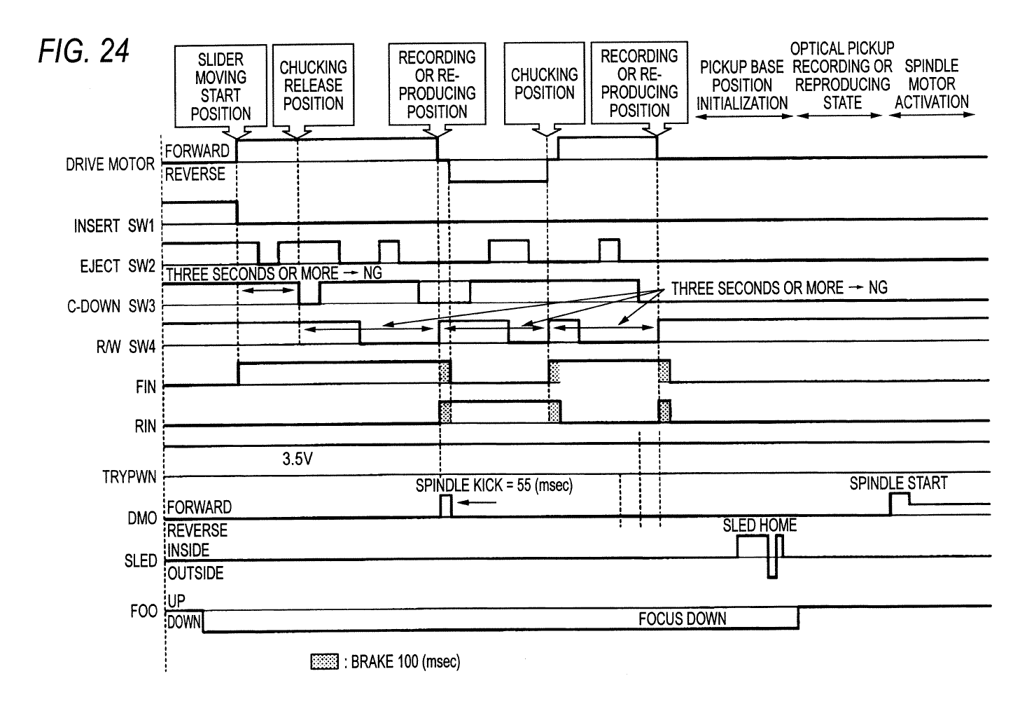

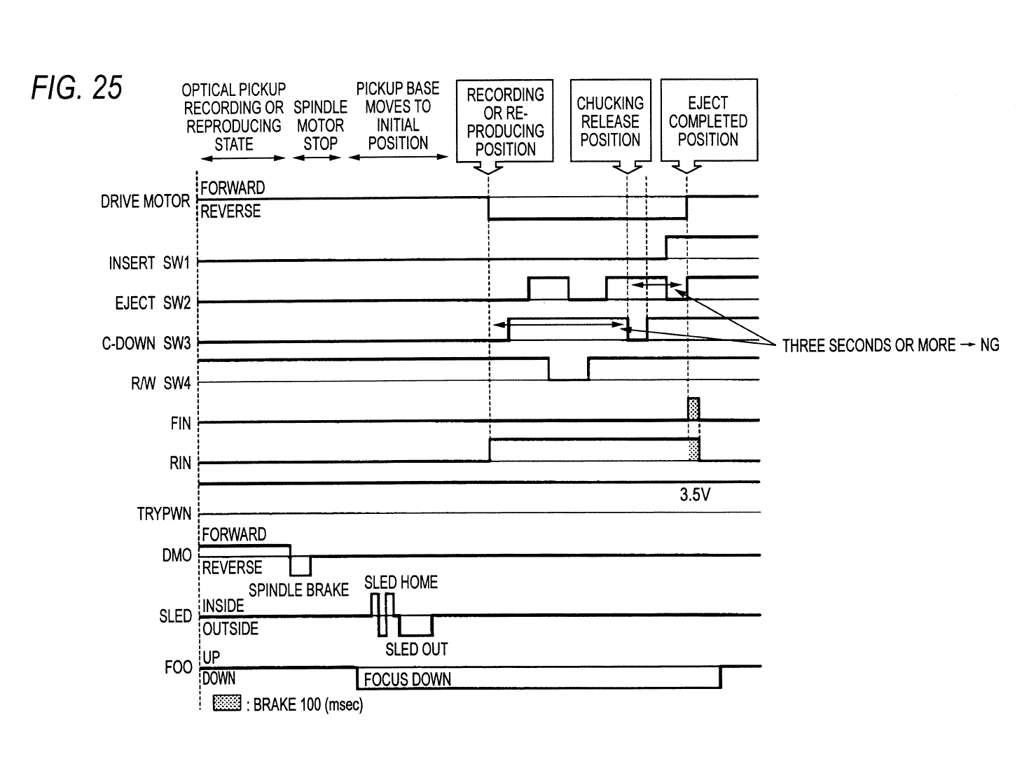

The disc drive 1 detects the conveying state of the optical disc 2 by monitoring the press states and the time of the first to fourth switches SW1 to SW4 and drives the drive motor 121, the spindle motor 24a, the movement driving mechanism 36, the optical pickup 25, and the like. Specifically, the conveying state of the optical disc 2 and the output timing of the motors are detected in accordance with the procedures in the timing diagram shown in FIGS. 24 and 25.

Before inserting the optical disc 2, as shown in FIG. 12, the slider 122 slides toward the disc slot 19 in the f₂ direction in FIG. 12. As a result, in the loading arm 51, the engagement protrusion 64 engages with the protrusion 69 of the loading cam plate 53, and the abutment 61 is pivoted to be maintained at a position retracted from the conveying area of the optical disc 2. In addition, the third link arm 94 being engaged with the slider 122 is pivoted in the c₂ direction in FIG. 12, and the eject arm 52 is actuated by the actuating arm 58 and the first link arm 54 so as to be pivoted and biased in the b₂ direction in FIG. 12. In addition, the sub slider 151 slides in the h₂ direction in FIG. 12 in accordance with the sliding movement of the slider 122 in the f₂ direction. As a result, the sub chassis 29 constituting the base unit 22 is lowered toward the bottom case 4 and retracted from the conveying area of the optical disc 2.

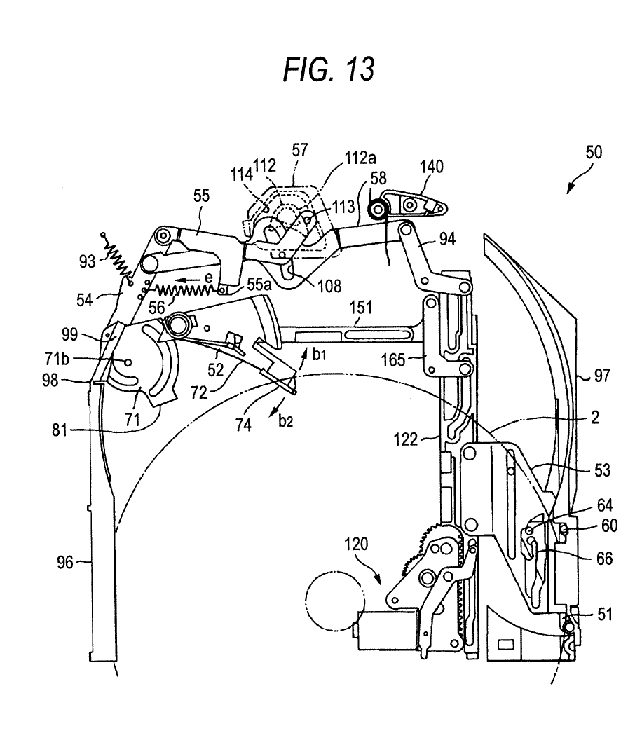

When the optical disc 2 is inserted into the disc slot 19 by the user, the abutment 61 of the eject arm 52 is pressed onto the insertion section of the optical disc 2 so that the eject arm 52 is pivoted in the b₁ direction in FIG. 13. In this case, since the pivot support member 71 is rotated in the b₁ direction about the attachment portion 71b, one end of the first link arm 54 connected to the pivot support member 71 is moved toward the left-side guide wall 96. Meanwhile, in the second link arm 55 engaged with the first link arm 54, the engagement protrusion 113 engaged with the guide groove 114 of the loop cam 57 is moved along the loading guide wall 112a. Since the loading guide wall 112a of the loop cam 57 is extended toward the right-side guide wall 97, the second link arm 55 is guided by the loading guide wall 112a so as to be separated from the first link arm 54. Accordingly, the first link arm 54 and the second link arm 55 is biased in a direction toward each other as the tension coil spring 56 between the first and second link arms is extended. In this case, in the second link arm 55, since the engagement protrusion 113 is in contact with the loading guide wall 112a, a biasing force is applied to the first link arm 54 in a direction opposite to the force directed to the spring locking portion 55a of the second link arm 55, i.e., the rotation direction of the pivot support member 71. Accordingly, the eject arm 52 is biased in the b₂ direction in FIG. 13, i.e., the ejecting direction of the optical disc 2.

Therefore, the optical disc 2 is inserted while resisting the biasing force applied to the eject arm 52 in the ejecting direction. Accordingly, it is possible to prevent the optical disc 2 from being left in a state where it is partly inserted into the housing 3 since the optical disc 2 is ejected out from the housing 3 even when the user stops the inserting of the optical disc 2.

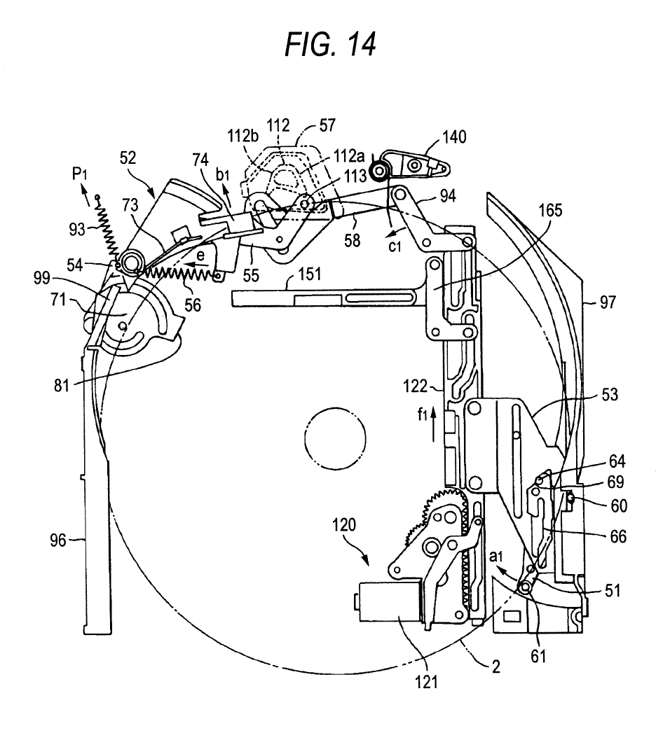

When the optical disc 2 is inserted by the user while resisting the biasing force and the eject arm 52 is pivoted to a predetermined angle, the bent part 81 of the pivot support member 71 presses the first switch SW1 installed in the circuit board 59, thereby actuating the driving mechanism 120. In this case, the press states of the first to fourth switches SW1 to SW4 become LHHH in this order and are detected by a micro-computer of the disc drivel (here, L stands for a pressed state, and H stands for a non-pressed state). The driving mechanism 120 is applied with the driving force of the drive motor 121 so as to allow the slider 122 to slide in the f₁ direction in FIG. 14. In this case, since the loading cam plate 53 is slid in the same direction together with the slider 122, the loading arm 51, the pivot movement of which has been restricted by the first cam groove 66, is biased by the coil spring 62 so as to be pivoted in the a₁ direction in FIG. 14, whereby the abutment 61 makes contact with the rear side surface of the optical disc 2. Accordingly, the loading of the optical disc 2 is performed.

When the eject arm 52 is pivoted to the actuating position of the driving mechanism 120, the guide protrusion 113 of the second link arm 55 is moved from the loading guide wall 112a of the loop cam 57 to the eject guide wall 112b. Accordingly, the first link arm 54 moves closer to the second link arm 55 and the coil spring 56 is compressed. As a result, the biasing force in the b₂ direction is not applied to the eject arm 52. Since the second link arm 55 is moved in the p₁ direction as the first link arm 54 is biased in the p₁ direction by the third link arm 93, the engagement protrusion 113 is moved from the loading guide wall 112a to the eject guide wall 112b so as to be disposed in the vicinity of the protrusion 112c.

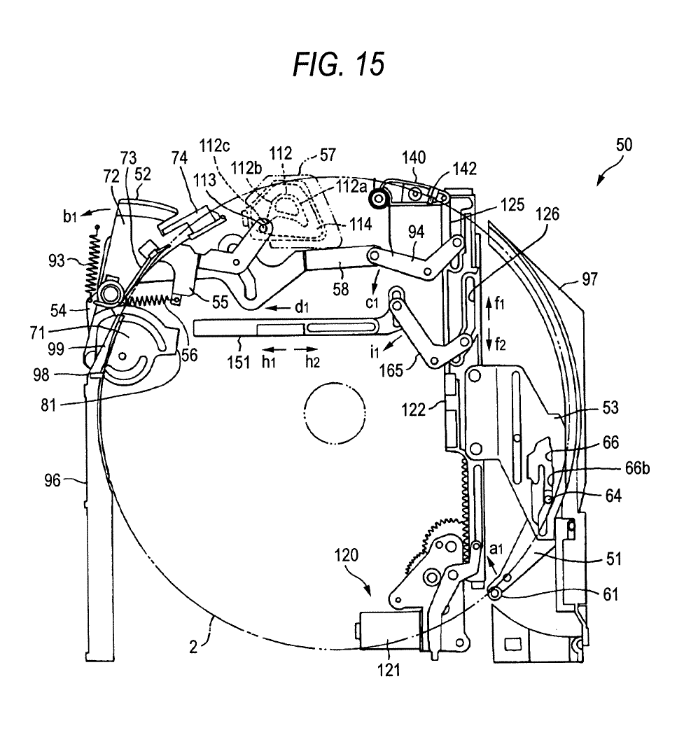

When the slider 122 slides in the f₁ direction, as shown in FIG. 15, the engagement protrusion 64 moves in the first cam groove 66 of the loading cam plate 53 from the first guide portion 66a to the second guide portion 66b. Accordingly, the loading arm 51 is pivoted in the a₁ direction in FIG. 15 so that the optical disc 2 is conveyed onto the disc mount 23. In this case, by detecting whether the press states of the first to fourth switches SW1 to SW4 became LHLH in this order, it can be known that the base unit 22 is lowered to the chucking release position. Accordingly, it is possible to stably convey the optical disc 2.

The optical disc 2 is loaded on the loading arm 51 and guided to the left- and right-side guide walls 96 and 97 so that the optical disc 2 makes contact with a stop lever 140 described later. Accordingly, the optical disc 2 is centered on the disc mount 23.

In addition, the third link arm 94 is guided to the first guide groove 125 of the slider 122 and pivoted in the c₁ direction in FIG. 15, whereby the actuating arm 58 engaged with the third link arm 94 is moved in the d₁ direction in FIG. 15. Accordingly, the first link arm 54 engaged with the other end 58b of the actuating arm 58 is pressed by the actuating arm 58 and moved toward the left-side guide wall 96. Moreover, since the pivot support member 71 is pivoted in the b₁ direction in FIG. 15 as the first link arm 54 is moved by the actuating arm 58, the compress arm 72 is pivoted in the same direction. In this case, the pressing part 90 formed in the compress arm 72 presses the centering guide part 99 of the left-side guide wall 96 protruded into the disc conveying area so that the centering guide part 99 is separated from the side surface of the optical disc 2.

Moreover, the engagement arm 165 engaged with the slider 122 is pivoted to allow the sub slider 151 to slide in the h₁ direction in FIG. 15, whereby the base unit 22 is raised to the chucking position. As a result, the optical disc 2 conveyed at the centering position is chucked on the turntable 23a with the peripheral portion of the central hole 2a being sandwiched between the turntable 23a and the engagement protrusion 8 formed in the periphery of the opening 7 of the top plate 5a.

In this case, by detecting whether the press states of the first to fourth switches SW1 to SW4 became LLHH in this order, it can be known that the base unit 22 is raised to the chucking position and the optical disc 2 is chucked on the turntable 23a. In the loading process of the optical disc 2 in the disc drive 1, after the optical disc 2 is chucked on the turntable 23a, a double chucking operation is performed in which the spindle motor 24a is driven to rotate the optical disc 2 by 180 degrees and the drive motor 121 in a reverse direction, thereby raising the base unit 22 to the chucking position again (see FIG. 24, for reference). Accordingly, it is possible to prevent the recording and reproducing operation from being performed in a state where the optical disc 2 is partly engaged with the turntable 23a.

When the slider 122 is further slid in the f₁ direction, the engagement protrusion 64 is moved from the second guide portion 66b of the loading cam plate 53 to the third guide portion 66c. Accordingly, the loading arm 51 is pivoted in the a₂ direction in FIG. 16 so that the abutment 61 is separated from the side surface of the optical disc 2.

When the slider 122 is slid in the f₁ direction and the sub slider 151 is slid in the h₁ direction again, the base unit 22 is lowered from the chucking position to the recording and reproducing position. The user's recording or reproducing operation is waited for. As shown in FIG. 16, the front end portion of the sub slider 151 collides with the bent part 81 of the pivot support member 71. As a result, the pivot support member 71 extends the biasing coil spring 93 and rotates in the b₁ direction in FIG. 16. Accordingly, the centered optical disc 2 is separated from the abutment member 71 of the eject arm 52. In addition, the first link arm 54 moves together with the pivot support member 71 and is biased in the p₁ direction by the biasing coil spring 93. Accordingly, the second link arm 55 engaged with the first link arm 54 is moved to the eject guide wall 112b over the protrusion 112c that prevents the reverse movement of the guide protrusion 113 toward the loading guide wall 112a.

As shown in FIG. 16, the slider 122 presses the top lever 140 assisting the centering of the optical disc 2 to be separated from the side surface of the optical disc 2. As a result, the optical disc 2 is separated from the loading arm 51 for assisting the centering, the eject arm 52, the stop lever 140, and the centering guide part 99 of the left-side guide wall 96 so as to be freely held on the turntable 23a, whereby the optical disc 2 is rotatable by the disc rotation driving mechanism 24.

In this case, by detecting whether the press states of the first to fourth switches SW1 to SW4 became LLLH in this order, it can be known that the base unit 22 is lowered to the recording and reproducing position and the optical disc 2 is in a rotatable state.

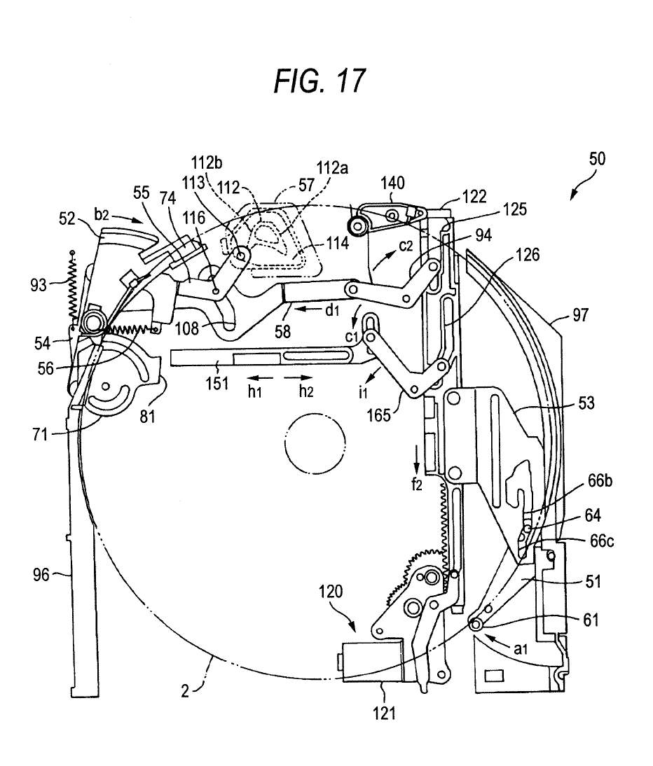

When the recording and reproducing operation is completed and an ejecting operation of the optical disc 2 is performed by the user, the drive motor 121 of the driving mechanism 120 is rotated in a reverse direction and the slider 122 is slid in the f₂ direction in FIG. 17. As a result, the engagement protrusion 64 is moved from the third guide portion 66c of the loading cam plate 53 to the second guide portion 66b and the loading arm 51 is pivoted in the a₁ direction in FIG. 17 so that the abutment 61 makes contact with the side surface of the optical disc 2.

Since the sub slider 151 is slid in the h₂ direction in FIG. 17 and the pressing toward the pivot support member 71 is released, the eject arm 52 is pivoted in the b₂ direction in FIG. 17 by the biasing coil spring 93 and the abutment 74 makes contact with the side surface of the optical disc 2. Since the first link arm 54 engaged with the pivot support member 71 is moved in the d₁ direction by the actuating arm 58 and the eject arm 52 only needs to be pivoted until it makes contact with the optical disc 2 by the compression of the biasing coil spring 93, an ejecting force is not applied to the optical disc 2.

When the slider 122 is further slid in the f₂ direction, the sub slider 151 is slid in the h₂ direction in FIG. 18, thereby lowering the base unit 22. As a result, the optical disc 2 is bounded up by the guide pin 180 erected from the bottom case 4 so that the chucking with the turntable 23a is released. Details of the guide pin 180 for releasing the chucking of the optical disc 2 will be described later.

In this case, by detecting whether the press states of the first to fourth switches SW1 to SW4 became LHLH in this order, it can be known that the base unit 22 is lowered to the chucking release position and the optical disc 2 can be stably ejected.

Thereafter, when the third link arm 94 engaged with the slider 122 slides in the first guide groove 125 of the slider 122 so as to be pivoted in the c₂ direction in FIG. 18, the actuating arm 58 is moved in the d₂ direction in FIG. 18. As shown in FIGS. 18 and 19, when the first link arm 54 is moved in the d₂ direction in accordance with the movement of the actuating arm 58 in the d₂ direction, the eject arm 52 is pivoted in the b₂ direction in FIG. 18 by the movement amount of the actuating arm 58, thereby ejecting the optical disc 2.

In this case, although in the disc conveying mechanism 50, the loading arm 51 biased in the a₁ direction in FIG. 18 where the optical disc 2 is biased in the inserting direction is in the abutted state by the coil spring 62, since the engagement protrusion 64 is engaged with the first cam groove 66 of the loading cam plate 53, the loading arm 51 can only be pivoted with the sliding movement of the loading cam plate 53 and is not freely pivotable forward and backward. In addition, when the loading cam plate 53 is slid in f₂ direction in FIG. 19 together with the slider 122, the loading arm 51 is pivoted in the a₂ direction in FIG. 19 against the biasing force of the coil spring 62. Accordingly, it does not add any biasing force that prevents the ejecting of the optical disc 2. In addition, it is possible to prevent abrupt jumping of the optical disc 2 by ejecting the optical disc 2 while being sandwiched between the loading arm 51 and the eject arm 52.

When the first link arm 54 is moved in the d₂ direction by the actuating arm 58, the guide protrusion 113 of the second link arm 55 slides on the eject guide wall 112b of the loop cam 57. In this case, since both the first link arm 54 and the second link arm 55 are moved in the same direction by the actuating arm 58, the tension coil spring 56 is not extended. That is, in the inserting of the optical disc 2, since the moving direction of the first link arm 54 due to the pivot movement of the eject arm 52 in the b₂ direction is opposite to the moving direction of the second link arm 55 due to the movement of the guide protrusion 113 that is guided to the loading guide wall 112a of the loop cam 57, the first link arm 54 and the second link arm 55 are separated from each other. Accordingly, the tension coil spring 56 is extended so as to apply the biasing force to the eject arm 52 in the ejecting direction. However, in the ejecting of the optical disc 2, since the guide protrusion 113 of the second link arm 55 is guided by the eject guide wall 112b so as to move in the same direction as the moving direction of the first link arm 54, the first link arm 54 and the second link arm 55 are not separated from each other. Accordingly, the tension coil spring 56 is not extended and the eject arm 52 is pivoted in the ejecting direction by the driving force of the driving mechanism 120 without being biased in the ejecting direction.

In this case, in the disc conveying mechanism 50, when the optical disc 2 slidingly collides with the panel curtain provided in the disc slot 19 of the front panel 18 so that the biasing force in the b₁ direction is applied to the eject arm 52 and the first link arm 54, the engagement protrusion 116 of the second link arm 55 makes contact with the sidewall of the cam groove 108 of the actuating arm 58 so as to restrict the rotation of the first link arm 54 in the d₂ direction. Accordingly, the first link arm 54 and the eject arm 52 is pivoted with the movement of the actuating arm 58 that is moved in the d₂ direction by the sliding amount of the slider 122 in the f₂ direction. Accordingly, in the disc conveying mechanism 50, it is possible to pivot the eject arm 52 against the biasing force in the b₁ direction by the sliding amount of the slider 122 and stably eject the optical disc 2 to a predetermined ejecting position.

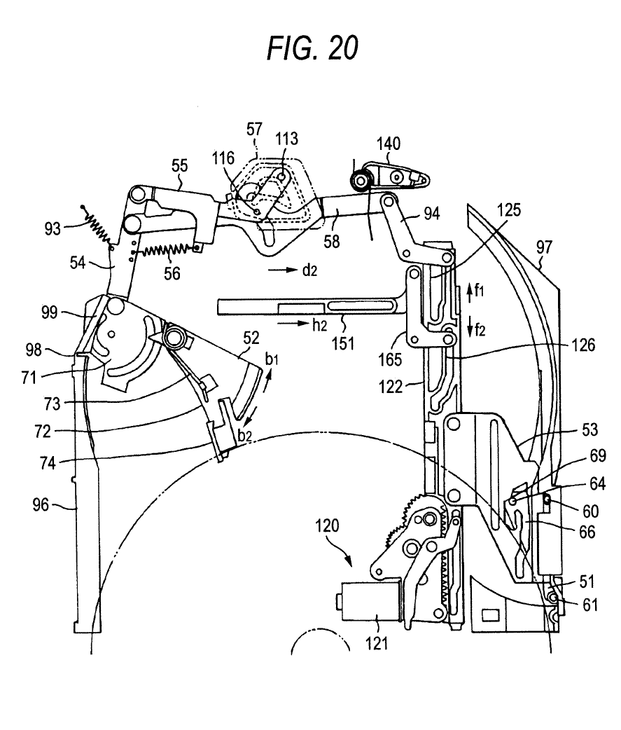

As shown in FIG. 20, when the slider 122 is moved to an initial position, the detection switch is pressed and the sliding movement is stopped. Accordingly, the eject arm 52 is pivoted to the initial position by the actuating arm 58 and the first link arm 54 so that the optical disc 2 is stopped at a position where the central hole 2a is ejected from the disc slot 19. In addition, in the loading arm 51, the engagement protrusion 64 engages with the protrusion 69 formed in the first cam groove 66 of the loading cam plate 53 and the abutment 61 is retracted from the conveying area of the optical disc 2.

In this case, by detecting whether the press states of the first to fourth switches SW1 to SW4 became HHHH in this order, it can be known that the optical disc 2 is conveyed by the eject arm 52 to the predetermined ejecting position. Then, driving of the drive motor 121 is stopped.

In this case, when the user perceives that he or she has erroneously inserted the optical disc 2 or grips abruptly the optical disc 2 in a state where the optical disc 2 is inserted to some extent and the driving of the drive motor 121 is started, the disc conveying mechanism 50 stops the drive motor 121 and drives the drive motor 121 in a reverse direction so as to eject the optical disc 2.

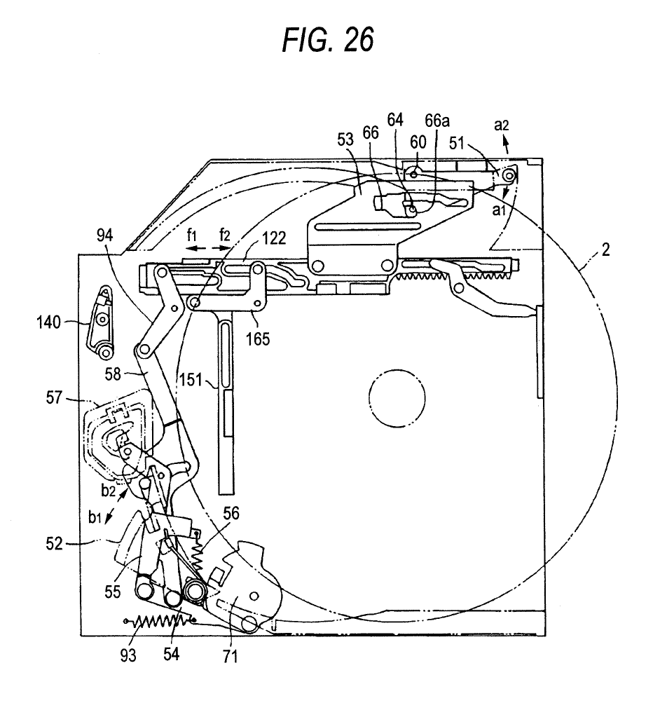

Specifically, as shown in FIG. 26, when the optical disc 2 is inserted through the disc slot 19 to some extent and the drive motor 121 is driven, the loading arm 51 is pivoted in the a₁ direction in FIG. 26 in accordance with the movement of the slider 122 and the loading cam plate 53 in the f₁ direction. When the user grips the optical disc 2, the pivot movement of the loading arm 51 is restricted and the loading cam plate 53 is slid in the f₁ direction together with the slider 122. Accordingly, the engagement protrusion 64 protruded from the loading arm 51 is fitted to the front end of the first guide portion 66a of the loading cam plate 53. As a result, the sliding movement of the slider 122 in the f₁ direction is restricted and the driving of the drive motor 121 is stopped. In this state, after a predetermined time period, the drive motor 121 is rotated in a reverse direction and the optical disc 2 is ejected in accordance with procedures contrary to the inserting procedures of the optical disc 2.

In this case, since the eject arm 52 is pivoted by a predetermined amount in accordance with the inserting of the optical disc 2 to a predetermined extent, the first and second link arms 54 and 55 are moved in a direction separated from each other and the tension coil spring 56 extended therebetween is extended. Accordingly, when the drive motor 121 is driven in a reverse direction and the slider 122 is slid in the f₂ direction, the eject arm 52 is pivoted in the b₂ direction in FIG. 26 as the first link arm 54 applied with the biasing force of the tension coil spring 56 rotates. As a result, in the disc drivel, the eject arm 52 is pivotably biased by the tension coil spring 56 in the b₁ direction in FIG. 26 where the optical disc 2 is ejected out from the disc slot 19, and the optical disc 2 is ejected by the biasing force of the tension coil spring 56. Accordingly, it is possible to prevent the optical disc 2 from being left in a state where it is partly inserted into the disc slot 19 due to the stopping of the drive motor 121 when the optical disc 2 is gripped in the course of inserting the optical disc 2.

Such an abnormal conveying of the optical disc 2 can be detected by the micro-computer by monitoring the press states of the first to fourth switches SW1 to SW4 installed in the circuit board 59. As shown in FIG. 24, when the time taken by the slider 122 to move after the first switch SW1 is pressed by the eject arm 52 before it is detected that the base unit 22 is lowered to the chucking release position (LHHH−LHLH) is equal to or greater than a predetermined time (for example, 3 seconds), or when the time taken by the base unit 22 to move from the chucking release position to the chucking position and the recording and reproducing position (LHLH−LLLH) is equal to or greater than the predetermined time, it is determined to be the abnormal conveying, the drive motor 121 is stopped and rotated in a reverse direction, thereby ejecting the optical disc 2.

When an obstacle such as books is disposed at the front side of the disc slot 19 in the course of ejecting the optical disc 2, the optical disc 2 comes in contact with the obstacle. Accordingly, the optical disc 2 is not ejected and excessive loads are applied to the drive motor 121 of the driving mechanism 120. In addition, the optical disc 2 is sandwiched between the obstacle and the eject arm 52 pivoted with the application of the driving force of the drive motor 121, thereby applying excessive loads to the optical disc 2.

In the disc drive 1, the pivot support member 71 of the eject arm 52 and the compress arm 72 are engaged therewith to be rotatable in the b₁ direction about the engagement portion 77 and biased with a predetermined force in the b₂ direction by the coil spring 73. Even when a force is applied to the eject arm 52 in a direction opposite to the ejecting direction of the optical disc 2 with the presence of the obstacle preventing the ejection of the optical disc 2 in the course of ejecting the optical disc 2, the compress arm 72 applied with the counter directional force is pivoted in the b₁ direction. Accordingly, it is possible to prevent application of excessive loads to the drive motor 121 or the optical disc 2.

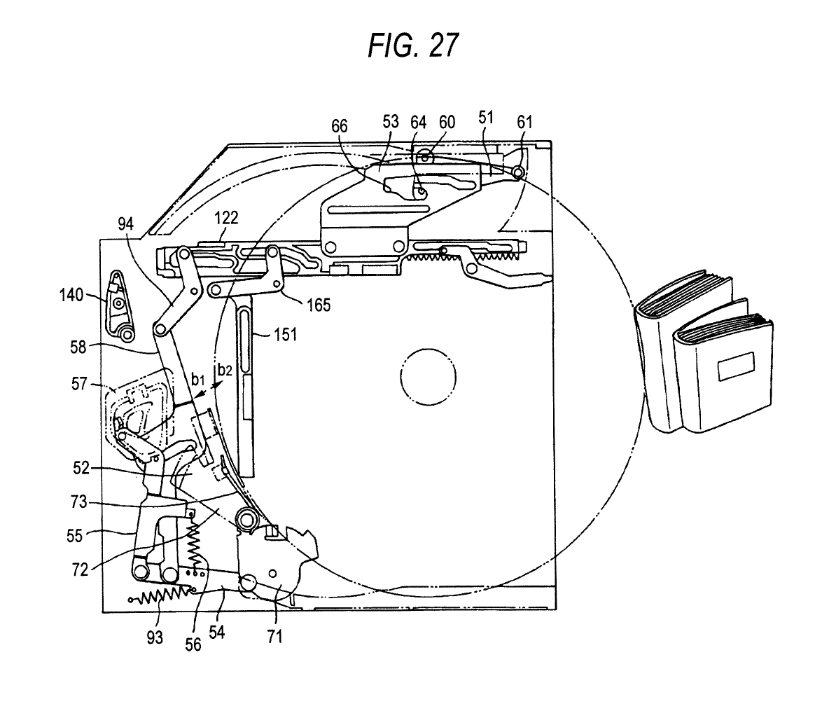

When the compress arm 72 of the eject arm 52 is pivoted in the b₁ direction, the disc drive 1 stops driving the drive motor 121. In this state, after a predetermined time has elapsed in a state that the obstacle is disposed in the front side of the disc slot 19 and the ejection of the optical disc 2 is prevented, the optical disc 2 is brought to the loading position. That is, as shown in FIG. 27, when the optical disc 2 is ejected to the outside from the disc slot 19, the side surface of the optical disc 2 makes contact with the obstacle, and the ejection of the optical disc 2 is stopped for a predetermined time, the drive motor 121 is rotated in an opposite direction. Accordingly, the first and second link arms 54 and 55 and the actuating arm 58 are moved in an opposite direction and the loading operation of the optical disc 2 is performed. Similarly, in this case, since the first link arm 54 and the second link arm 55 are not separated from each other, the tension coil spring 56 is not extended and the biasing force in the ejecting direction is not applied to the eject arm 52.

With this arrangement, in the disc drivel, it is possible to prevent the optical disc 2 from being left in a state where it is sandwiched between the eject lever 52 pivoted in the ejecting direction and the obstacle and the application of excessive loads from being applied to the drive motor 121 or the optical disc 2.

Such an abnormal conveying of the optical disc 2 can be detected by the micro-computer by monitoring the press states of the first to fourth switches SW1 to SW4 installed in the circuit board 59. As shown in FIG. 25, when the time taken by the slider 122 to move after the drive motor 121 is rotated in a reverse direction before the base unit 22 is lowered from the recording and reproducing position to the chucking position and the chucking release position (LLLH−LHLH) is equal to or greater than a predetermined time (for example, 3 seconds), or when the time taken by the slider 122 to move after the base unit 22 is lowered to the chucking release position before the states of the first to fourth switches SW1 to SW4 are changed to the non-pressed state (LHLH−HHHH) is equal to or greater than the predetermined time, it is determined to be the abnormal conveying, the drive motor 121 is stopped and rotated in a normal direction, thereby loading the optical disc 2.

In the disc conveying mechanism 50 of the disc drive 1 according to the embodiment of the invention, in the course of the user's inserting the optical disc 2 to the predetermined position at the time of inserting the optical disc 2, by guiding the first link arm 54 and the second link arm 55 in a direction separated from each other with the loop cam 57, the biasing force is applied to the eject arm 52 in the ejecting direction by the tension coil spring 56 extended between the first and second link arms 55 and 56. Accordingly, it is possible to prevent the optical disc 2 from being left in a state where it is partly inserted into the housing 3 due to the user's stopping the inserting of the optical disc 2.

In addition, when ejecting the optical disc 2, the first link arm 54 and the second link arm 55 are moved by the loop cam 57 so as to be disposed closer to each other, thereby removing the biasing force of the extension coil spring 56 in the ejecting direction applied to the eject arm 52. Accordingly, the eject arm 52 is pivoted with the movement of the slider 122 and the actuating arm 58 by the driving force of the driving mechanism 120. Therefore, the disc conveying mechanism 50 can stably eject the optical disc 2 to a predetermined stop position at which the central hole 2a of the optical disc 2 is located outside the housing 3 by the driving force of the driving mechanism 120 without relying on the elastic force.

In addition, since the disc conveying mechanism 50 does not use a mechanism for pivoting the eject lever 52 by the biasing force of the tension coil spring 56 when ejecting the optical disc 2, it does not produce any sound when the eject lever 52 applied with the biasing force makes contact with the optical disc 2. Accordingly, in the disc drive 1, it is possible to remove the noise at the time of ejecting the optical disc 2 and improve the sense of usability.

In the disc drive 1 according to the embodiment of the invention, a stopper 100 for prevent ing the erroneous insertion of the small-diameter optical disc 101 may be formed in the abutment member 74 of the eject arm 52. That is, although the disc drive 1 is designed for use with the optical disc 2 having a greater diameter (for example, a diameter of 12 cm), it considers a case where an optical disc 101 having a small diameter (for example, a diameter of 8 cm) is erroneously inserted by a user. In this case, when the small-diameter disc 101 makes contact with the abutment member 74 and the eject arm 52 is pushed in the b₁ direction, the eject arm 52 is not pivoted to a position where the driving mechanism 120 is actuated. Therefore, it is possible to eject the small-diameter disc 101 by the biasing force in the b₂ direction. Meanwhile, when the small-diameter disc 101 is slantly inserted toward the side of the loading arm 51 so as not to be in contact with the abutment member 74 of the eject arm 52, the small-diameter disc 101 may be inserted deeply into the housing 3 and left at a position apart from the pivot area of the eject arm 52.

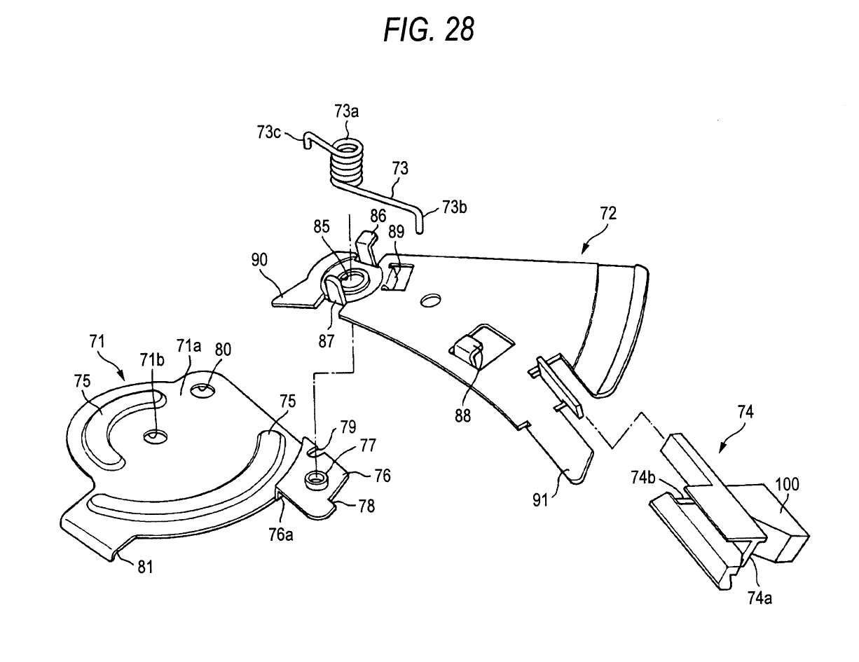

Therefore, as shown in FIG. 28, the stopper 100 for preventing the erroneous inserting of the small-diameter disc 101 is formed in the abutment member 74 of the eject arm 52 in order to prevent the disc 101 from being inserted deeply into the housing 3 even when the disc 101 is slantly inserted toward the side of the loading arm 51.

The stopper 100 is protruded more toward the loading arm 51 than the abutment member 74. Even when the disc 101 is slantly inserted toward the side of the loading arm 51, the disc 101 makes contact with a portion of the stopper 100, thereby making it possible to prevent a further erroneous insertion.

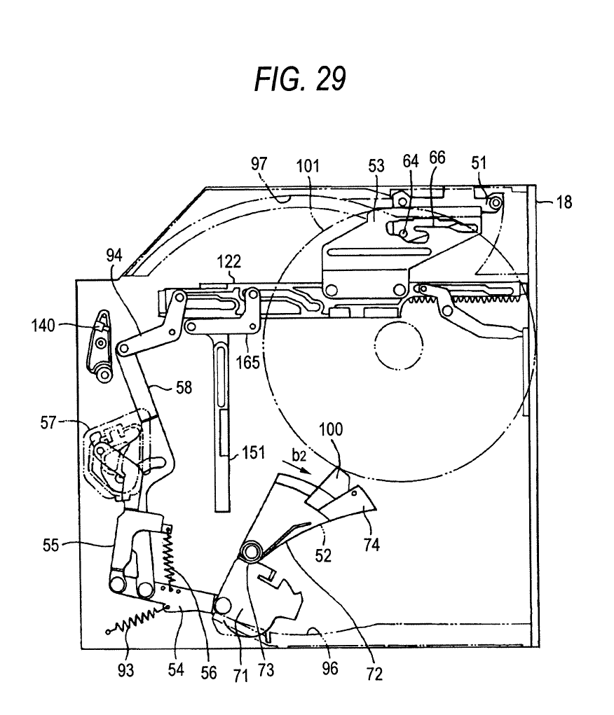

In addition, when it is in the insertion waiting state of the optical disc 2 where the eject arm 52 is pivoted in the b₂ direction in FIG. 29, the stopper 100 has a smaller clearance from the end portion of the loading arm 51 of the disc slot 19 than the diameter of the small-diameter disc 101. Therefore, the stopper 100 can securely prevent the erroneous insertion even when the small-diameter disc 101 is slantly inserted toward the side of the loading arm 51.

When approximately the entire small-diameter disc 101 is inserted into the disc slot 19 in the insertion waiting state of the optical disc 2, the stopper 100 is pivoted to a position where the eject arm 52 makes contact with the insertion section of the small-diameter disc 101. That is, the stopper 100 makes contact with the disc 101 when approximately the entire small-diameter disc 101 is inserted into the disc slot 19. Therefore, the small-diameter disc 101 comes in contact with the stopper 100 in a state where there is left a little part of the disc 101 remaining outside the disc slot 19 after being inserted thereto, thereby restricting a further insertion. Accordingly, the user may be difficult to insert the small-diameter disc 101 further into the housing 3.

The stopper 100 is pivoted on the disc conveying area in the b₁ and b₂ directions together with the eject arm 52. In this case, by designing the eject arm 52 to have a length to an extent that the stopper 100 is not pivoted on the disc mount 23 of the base unit 22 that is exposed to the disc conveying area, it is possible to prevent the stopper 100 from being fluctuated in the course of the pivot movement of the eject arm 52 and from colliding with the turntable 23a of the disc mount 23 or the engagement protrusion 33a.

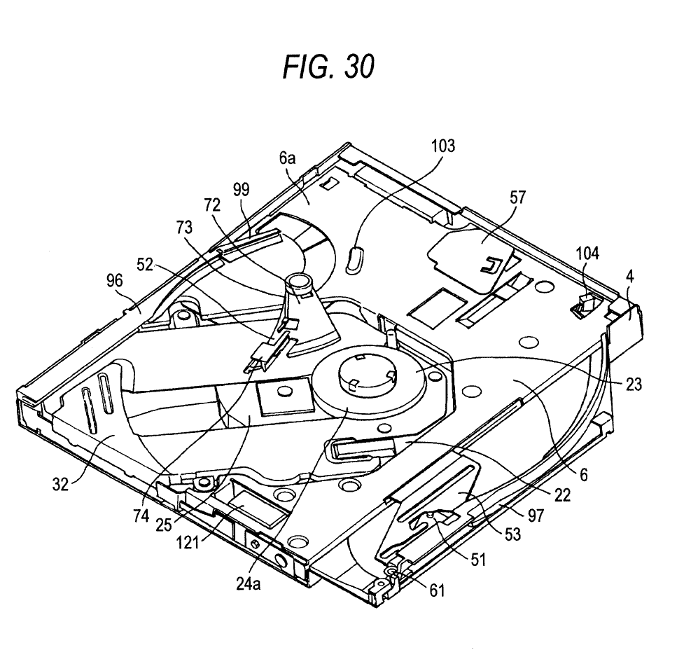

As shown in FIG. 30, in the disc drive 1 according to the embodiment of the invention, a protrusion 103 allowing the eject arm 52 to be pivoted so as to prevent the collision of the eject arm 52 with the disc mount 23 may be provided in the top surface 6a of the main chassis 6. The protrusion 103 is formed on an area where the compress arm 72 of the eject arm 52 is pivoted on the top surface 6a of the main chassis 6, and disposed at a position where the compress arm 72 is placed when the abutment member 74 of the eject arm 52 passes above or around the disc mount 23.

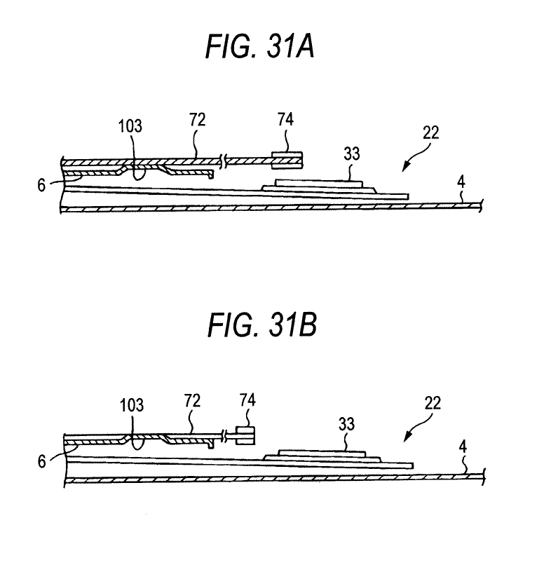

Therefore, when the optical disc 2 is inserted and the eject arm 52 is pivoted in the b₁ direction, the compress arm 72 is placed above the protrusion 103 so that the abutment member 74 is raised. As shown in FIG. 31A, the trajectory of the abutment member 74 or the optical disc 2 supported by the abutment member 74 is also raised, thereby preventing the collision with the turntable 23a of the disc mount 23 or the engagement protrusion 33a.

It should be noted that the forming position of the protrusion 103 is restricted to those positions where the compress arm 74 is placed when the abutment member 74 of the eject arm 52 passes above or around the disc mount 23. Therefore, the pivot trajectory of the eject arm 52 is not raised in other positions where the protrusion 103 is not formed. It is unnecessary to secure the pivot height of the eject arm 52 across the entire pivot area, contrary to the case where the protrusion is provided to the side of the eject arm 52. That is, when a protrusion protruded downward is formed in the eject arm 52, the protrusion is always placed above the top surface 6a of the main chassis 6, thereby raising the trajectory of the eject arm 52 all the way. In addition, it is necessary to raise the trajectory of the eject arm 52 in other areas of the main chassis 6 in order to prevent the collision of the downwardly protrusion with other parts. As a result, the thickness of the housing 3 is increased and it is thus difficult to make the disc drive 1 in a compact and slimmer profile. When the eject arm 52 is fluctuated in the course of the pivot movement by external disturbance, the protrusion may slidingly contact or collide with other parts, such as the optical pickup 25, disposed below the protrusion.

In the disc drive 1 according to the embodiment of the invention, since the protrusion 103 is formed on the top surface 6a of the main chassis 6, the trajectory of the eject arm 52 is raised at the only position where the eject arm 52 is placed above the protrusion 103 and is not raised at other positions. As shown in FIG. 31B, since the downwardly protrusion is not formed in the eject arm 52, there is little possibility of colliding with other parts disposed below the pivot area of the eject arm 52. It is possible to make the housing 3 in a compact and slimmer profile.

The driving mechanism 120 that supplies the driving force to the disc conveying mechanism 50 includes the drive motor 121, the slider 122 applied with the driving force of the drive motor 121 sliding in the bottom case 4, and a gear train 123 transferring the driving force of the drive motor 121 to the slider 122, which are all mounted on the main chassis 6. The driving mechanism 120 drives the disc conveying mechanism 50 and the base lifting mechanism 150 by allowing the slider 122 to slide using the drive motor 121.

When the optical disc 2 is inserted to a predetermined position, the first switch SW1 is pressed by the pivot support member 71 of the eject arm 52 so that the drive motor 121 is driven in the normal direction where the slider 122 is moved in the f₁ direction. When an eject operation is performed, the drive motor 121 is driven in the reverse direction where the slider 122 is moved in the f₂ direction. The slider 122 is moved in the f₁ or f₂ direction in FIG. 12 in accordance with the loading and ejecting of the optical disc 2, thereby driving those arms of the disc conveying mechanism 50 or the base lifting mechanism 150. The gear train 123 transfers the driving force of the drive motor 121 to the slider 122 through a rack portion 131.

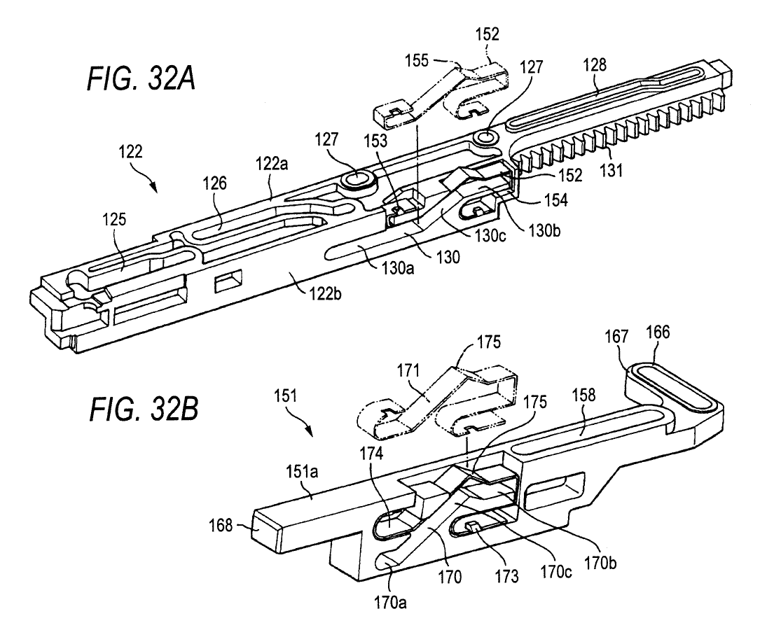

As shown in FIG. 32A, the slider 122 is made of a resin having approximately rectangular solid shape and includes at the top surface 122a thereof, the first guide groove 125 engaging with the engagement protrusion 109 formed in the third link arm 94, the second guide groove 126 engaging with the connecting arm 165 for driving the sub slider 151 of the base lifting mechanism 150, a pair of engagement concave portions 127, 127 engaging with the pair of engagement protrusions 68, 68 formed in the loading cam plate 53, and a third guide groove 128 engaging with an end of a shutter arm 191 of a disc insertion restricting mechanism 190, which will be described later.

The slider 122 includes at a side surface 122b on the side of the base unit 22, the first cam slit 130 through which the first spindle 47 protruded from the sub chassis 29 of the base unit 22 and the rack portion 131 engaging with the gear train 123. A first guide plate 152 preventing clattering of the first spindle 47 of the sub chassis 29 and stably operating the disc rotation driving mechanism 24 is mounted above the first cam slit 130. The slider 122 includes at a bottom surface 122c, a slider guide groove 129 in which the sliding direction is guided by the pair of guide protrusions 124, 124 protruded from the bottom case 4 and which is disposed along the longitudinal direction (see FIG. 7 for reference).

The slider 122 is disposed in the bottom surface of the bottom case 4 between the one side surface of the bottom case 4 and the base unit 22. The slider 122 is also disposed at a height lower than the optical disc 2 inserted into the inside of the housing 3 through the disc slot 19, and the top surface of the slider 122 is disposed slightly lower than the deck portion 4a. The slider 122 is covered by the main chassis 6 and slidingly moved forward and backward through the drive motor 121 or the gear train 123 provided on the bottom surface of the bottom case 4.

In the driving mechanism 120, the third link arm 94 and the actuating arm 58 engaged with the third link arm 94 are moved in accordance with the sliding movement of the slider 122, thereby restricting the pivot movement of the eject arm 52 and moving the loading cam plate 53 forward and backward so as to pivot the loading arm 51. With this arrangement, the driving mechanism 120 performs the loading operation in which the optical disc 2 is brought into the housing 3 through the disc slot 19 in accordance with the sliding movement of the slider 122 and the ejecting operation in which the optical disc 2 is ejected from the disc mount 23 to the outside of the disc slot 19.

Next, the stop lever 140 performing the centering operation of positioning the loaded optical disc 2 on the disc mount 23 will be described. As shown in FIG. 6, the stop lever 140 includes a lever body 141 pivotably supported on the main chassis 6, a stop protrusion 142 protruded from an end of the lever body 141 and stopping the optical disc 2 at the centering position, a support protrusion 143 which is inserted into a circular portion of the coil spring 144 and allows the lever body 141 to be pivotably supported on the main chassis 6 at the other end of the lever body 141, and a restricting protrusion 145 which is inserted into the guide hole 146 pored into the main chassis 6 and restricts the pivot movement of the lever body 141 so as to allow the stop protrusion 142 to stop at the centering position of the optical disc 2.

The lever body 141 is made of a resin material, one end 141a having the stop protrusion 142 protruded therefrom has an approximately circular arc shape, and the support protrusion 143 is supported on the main chassis 6, whereby the end 141a is protruded from the sliding area of the slider 122. With this arrangement, when the front end of the slider 122 makes contact with the lever body 141 in accordance with the sliding movement of the slider 122, the stop lever 140 is pivotable about the support protrusion 143.

Since the stop protrusion 142 is protruded from the one end of the lever body 141, the stop protrusion 142 is protruded from the pivot hole 147 formed in the main chassis 6 to the top surface 6a of the main chassis 6, thereby making contact with the periphery of the optical disc 2. Since the stop protrusion 142 makes contact with the side surface on the insertion section side of the optical disc 2 brought inward by the loading arm 51, the stop protrusion 142 performs the centering operation in which the optical disc 2 is stopped at the disc mount 23. Since the pivot hole 147 allowing the stop protrusion 142 to be protruded above the main chassis 6 has an approximately circular arc shape, the stop protrusion 142 is retracted from the stop position for centering the optical disc 2.

The support protrusion 143 is a cylindrical member having a hollow obtained by cutting a screw groove and protrudes from the other end of the lever body 141. Since the hollow is continuously fixed with screws through the screw groove pored into the main chassis 6, the support protrusion 143 is rotatably supported on the main chassis 6 in the g₁ and g₂ directions in FIG. 12. The support protrusion 143 is inserted into the circular portion of the coil spring 144. An end of the coil spring 144 is fitted to the lever body 141 and the other end of the coil spring 144 is fitted to the circuit board 59 mounted on the bottom case 4. With this arrangement, the stop lever 140 is pivotably biased in the g₁ direction in FIG. 12 about the support protrusion 143.

The restricting protrusion 145 restricts the pivot area of the lever body 141 pivotably biased by the coil spring 144. As shown in FIG. 3, the restricting protrusion 145 is protruded upward from the lever body 141 and extended from the guide hole 146 formed in the main chassis 6 to the top surface 6a of the main chassis 6. The guide hole 146 restricts the pivot area of the restricting protrusion 145 so that the lever body 141 pivotably biased in the g₁ direction by the coil spring 144 is stopped at a predetermined position for centering the optical disc 2. Since the guide hole 146 has a circular arc shape, the lever body 141 is retracted from the stop position for centering the optical disc 2.

In the stop lever 140, the lever body 141 is biased by the coil spring 144 and the restricting protrusion 145 engages with an end on the arrow g₁ side of the guide hole 146, whereby the stop protrusion 142 is pivoted to the stop position for stopping the optical disc 2 at the centering position. In the stop lever 140, the side surface on the insertion section side of the optical disc 2 comes in contact with the stop protrusion 142 when the optical disc 2 is loaded. As a result, the stop lever 140 positions the optical disc 2 on the disc mount 23. When the centering operation is completed, the stop lever 140 is pivoted in the g₂ direction with the end 141a of the lever body 141 being pressed on the front end of the slider 122 conveyed in f₁ direction. As a result, the stop protrusion 142 is separated from the periphery of the optical disc 2 so that the optical disc 2 is in a rotatable state. When the optical disc 2 is ejected, the stop lever 140 is biased by the coil spring 144 as the slider 122 is slid in the f₂ direction, and the stop protrusion 142 is pivoted to the stop position where the optical disc 2 is stopped at the centering position to be prepared for the loading of the optical disc 2.

Next, the base lifting mechanism 150 moving the base unit 22 upward or downward in accordance with the sliding movement of the slider 122 will be described. The base lifting mechanism 150 moves the base unit 22 upward or downward between a chucking position at which the base unit 22 is moved upward to allow the optical disc 2 positioned at the disc mount position to be placed on the turntable 23a of the disc mount 23, a chucking release position at which the base unit 22 is moved downward to allow the optical disc 2 to be released from the turntable 23a of the disc mount 23, and a recording and reproducing position at which the base unit 22 is placed between the chucking position and the chucking release position so as to perform an operation of recording or reproducing signals on or from the optical disc 2.

Specifically, the base lifting mechanism 150 moves the base unit 22 upward and downward by allowing the slider 122 and the sub slider 151 sliding with the sliding movement of the slider 122 to move the first spindle 47 and the second spindle 48 formed in the base unit 22 upward and downward. As shown in FIG. 32A, on the side surface of the slider 122 facing the base unit 22, there is formed the first cam slit 130 that extends across the longitudinal direction and moves the base unit 22 upward and downward between the chucking release position and the recording and reproducing position. The first cam slit 130 includes a lower horizontal portion 130a corresponding to the chucking release position, an upper horizontal portion 130b corresponding to the recording and reproducing position, and a slant surface portion 130c connecting the lower horizontal portion 130a and the upper horizontal portion 130b. The first spindle 47 protruded from the sub chassis 29 of the base unit 22 is slidably inserted into the first cam slit 130.

As shown in FIG. 32A, the first guide plate 152 guiding the movement of the first spindle 47 and preventing clattering of the first spindle 47 in the recording and reproducing position, thereby stably operating the disc rotation driving mechanism 24 is mounted above the first cam slit 130. The first guide plate 152 is made of a planar spring member and includes an end fitted to the locking part 153 formed in the upper portion of the first cam slit 130 and the other end fitted to the locking concave portion 154 formed on the lower side of the first cam slit 130. A protrusion 155 which is protruded toward the top surface 122a of the slider 122 when the base unit 22 is moved upward to the chucking position and the first spindle 47 is moved to the upper horizontal portion 130b is bent from the first guide plate 152 above the contact point between the upper horizontal portion 130b and the slant surface portion 130c.

The lower horizontal portion 130a of the first cam slit 130 has a height slightly greater than the diameter of the first spindle 47 so as to be slidable upward and downward. The distance in a vertical direction between the upper horizontal portion 130b and the first guide plate 152 is equal to or slightly smaller than the diameter of the first spindle 47. Therefore, when the first spindle 47 moves toward the upper horizontal portion 130b, the first guide plate 152 presses the first spindle 47 so as to be sandwiched between the upper horizontal portion 130b and the first guide plate 152. Accordingly, the first guide plate 152 restricts vibration of the spindle motor 24a of the disc rotation driving mechanism 24 provided on the base unit 22, thereby making it possible to stably rotate the optical disc 2.

The first guide plate 152 grips the first spindle 47 to be sandwiched by the upper horizontal surface 130b so that the protrusion 155 is protruded toward the top surface 122a of the slider 122 and pressed by the top surface 6a of the main chassis 6. Accordingly, the slider 122 is pressed toward the bottom case 4 by the first guide plate 152, thereby making it possible to prevent influence of vibration or external disturbance due to the driving of the base unit 22.

The sub slider 151 is disposed so as to support the second spindle 48 protruded from the sub chassis 29 of the base unit 22, engage with the slider 122, and slide in the h₁ and h₂ directions in FIG. 12 perpendicular to the loading direction of the optical disc 2 in accordance with the sliding movement of the slider 122.

As shown in FIG. 32B, the sub slider 151 is made of a synthetic resin member having an elongated flat plate shape and includes on a top surface 151a, a top guide groove 158 engaging with a guide protrusion 157 protruded from the main chassis 6 and extending in the longitudinal direction. The sub slider 151 includes at a bottom surface 151b, a bottom guide groove 160 engaging with a guide protrusion 159 protruded from the bottom case 4 at a position displaced from the top guide groove 158 (see FIG. 7 for reference). In the sub slider 151, when the guide protrusion 157 protruded from the main chassis 6 engages with the top guide groove 158, the guide protrusion 157 slides in the top guide groove 158. When the guide protrusion 159 protruded from the bottom chassis 4 engages with the bottom guide groove 160, the guide protrusion 159 slides in the bottom guide groove 160. As a result, the sub slider 151 is slid in the h₁ or h₂ direction in accordance with the sliding movement of the slider 122.

On an end of the sub slider 151 on the side of the slider 122 in the longitudinal direction, an engagement groove 166 engaging with a connection arm 165 connected to the slider 122 is formed. The engagement groove 166 is provided in the engagement part 167 extending in a direction perpendicular to the longitudinal direction of the sub slider 151. The sub slider 151 includes an end having the engagement part 167 formed thereon and the other end constituting the abutment protrusion 168 making contact with the pivot support member 71 of the eject arm 52 at the time of loading the optical disc 2. When the pivot support member 71 makes contact with the bent part 81 at the loading time of the optical disc 2, the abutment protrusion 168 allows the guide protrusion 113 of the second link arm 55 connected to the first link arm 54 through the first link arm 54 connected to the pivot support member 71 to move over the protrusion 112c of the loop cam 57 and allows the eject arm 54 to pivot until the abutment member 74 is released from the side surface of the optical disc 2.

On the side surface 151b of the sub slider 151 on the side of the disc slot 19, a second cam slit 170 moving the base unit 22 upward and downward between the chucking position, the chucking release position, and the recording and reproducing position is disposed in the longitudinal direction together with the first cam slit 130. The second cam slit 170 includes a lower horizontal portion 170a corresponding to the chucking release position, an upper horizontal portion 170b corresponding to the recording and reproducing position, and a slant surface portion 170c connecting the lower horizontal portion 170a and the upper horizontal portion 170b. The second spindle 48 protruded from the sub chassis 29 of the base unit 22 is slidably inserted into the second cam slit 170.

The slant surface portion 170c of the second cam slit 170 extends to a position higher than the upper horizontal portion 170b and goes slightly down, thereby guiding the base unit 22 toward the upper horizontal portion 170b. As a result, the base unit 22 guided in the second cam slit 170 is moved from the chucking release position to the chucking position when the sub slider 151 is slid in the h₁ direction and the second spindle 48 moves upward from the lower horizontal portion 170a to the slant surface portion 170c. In this case, the base unit 22 chucks the optical disc 2 with the periphery of the central hole 2a of the optical disc 2 conveyed on the disc mount 23 sandwiched between the turntable 23a and the abutment protrusion 8 provided in the top plate 5a of the top cover 5. When the sub slider 151 slides in the h₁ direction, the second spindle 48 moves downward from the slant surface portion 170c to the upper horizontal portion 170b, whereby the base unit 22 is moved from the chucking position to the recording and reproducing position.

Similarly to the first cam slit 130, as shown in FIG. 32B, a second guide plate 171 guiding the movement of the second spindle 48 and preventing clattering of the second spindle 48 in the recording and reproducing position, thereby stably operating the disc rotation driving mechanism 24 is mounted above the second cam slit 170. The second guide plate 171 is made of a planar spring member and includes an end fitted to the locking part 173 formed in the upper portion of the second cam slit 170 and the other end fitted to the locking concave portion 174 formed on the lower side of the second cam slit 170. A protrusion 175 which is protruded toward the top surface 151a of the sub slider 151 when the base unit 22 is moved upward to the chucking position and the second spindle 48 is moved to the upper horizontal portion 170b is bent from the second guide plate 171 above the contact point between the upper horizontal portion 170b and the slant surface portion 170c.

The lower horizontal portion 170a of the second cam slit 170 has a height slightly greater than the diameter of the second spindle 48 so as to be slidable upward and downward. The distance in a vertical direction between the upper horizontal portion 170b and the second guide plate 171 is equal to or slightly smaller than the diameter of the second spindle 48. Therefore, when the second spindle 48 moves toward the upper horizontal portion 170b, the second guide plate 171 presses the second spindle 48 so as to be sandwiched between the upper horizontal portion 170b and the second guide plate 171. Accordingly, the second guide plate 171 restricts vibration of the spindle motor 24a of the disc rotation driving mechanism 24 provided on the base unit 22 together with the first guide plate 152, thereby making it possible to stably rotate the optical disc 2.

The second guide plate 171 grips the second spindle 48 to be sandwiched by the upper horizontal surface 170b so that the protrusion 175 is protruded toward the top surface 151a of the sub slider 151 and pressed by the top surface 6a of the main chassis 6. Accordingly, the sub slider 151 is pressed toward the bottom case 4 by the second guide plate 171, thereby making it possible to prevent influence of vibration or external disturbance due to the driving of the base unit 22.

The connecting arm 165 engaging with the engagement groove 166 of the sub slider 151 and connecting the slider 122 and the sub slider 151 to each other has an approximately L-shape. The bent portion 165a is pivotably mounted on the main chassis 6, and an engagement protrusion 177 formed on an end 165b on a transverse side extended from the bent portion 165a movably engages with the second guide groove 126 of the slider 122, whereby the engagement protrusion 178 formed on the other end 165c on a longitudinal side movably engages with the engagement groove 166 of the sub slider 151.

When the slider 122 moves in the f₁ direction and the engagement protrusion 177 moves in the second guide groove 126 of the slider 122, the connecting arm 165 is rotated about the bent portion 165a in the i₁ direction, whereby the engagement protrusion 178 moves in the engagement groove 166 so as to allow the sub slider 151 to slide in the h₁ direction. When the slider 122 moves in the f₂ direction and the engagement protrusion 177 moves in the second guide groove 126, the connecting arm 165 is rotated about the bent portion 165a in the i₂ direction, whereby the engagement protrusion 178 moves in the engagement groove 166 so as to allow the sub slider 151 to slide in the h₂ direction.

As shown in FIGS. 3, 6 and 33, the disc drive 1 is provided with the guide pin 180 guiding the base unit 22 so that the central hole 2a of the optical disc 2 conveyed to the centering position by the disc conveying mechanism 50 is arranged to the turntable 23a of the disc mount 23 provided in the base chassis 27 when the base unit 22 is raised to the chucking position.

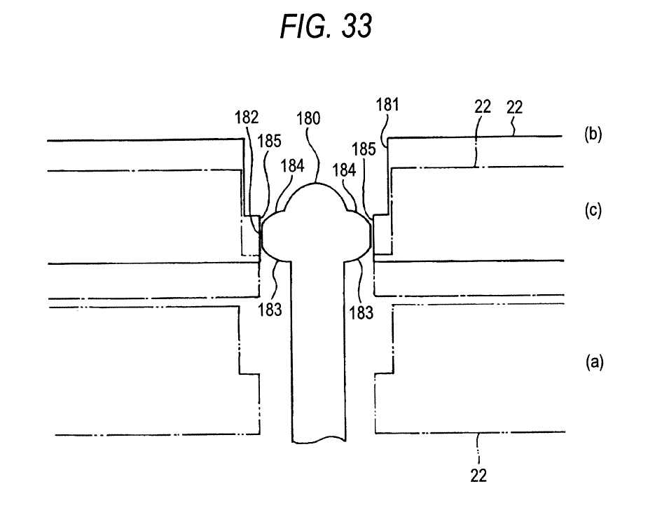

The guide pin 180 is erected from the bottom surface of the bottom case 4, and a flange portion 182 that is inserted into the guide hole 181 formed in the base chassis 27 is formed below the guide pin 180, as shown in FIG. 33. The flange portion 182 has a diameter slightly greater than that of the guide hole 181 of the base chassis 27. The flange portion 182 includes a first guide portion 183 including a slope with a diameter increasing upwardly and a second guide portion 184 including a slope with a diameter decreasing upwardly. When the base chassis 27 moves upward, the first and second guide portions 183 and 184 make sliding contact with the guide wall 185 formed in the guide hole 181, whereby the flange portion 182 guides the base unit 22 to the chucking position or the chucking release position.

The guide hole 181 of the base chassis 27 through which the guide pin 180 is inserted is pored in the vicinity of the turntable 23a separated from the third spindle 49 serving as a pivot point of the base unit 22. As shown in FIG. 33, the guide wall 185 is swelled in the guide hole 181 at the lower portion of the base chassis 27. The guide wall 185 forms a clearance slightly greater than the diameter of the flange portion 182 of the guide pin 180, and the flange portion 182 passes through the clearance, whereby the base unit 22 is guided so that the central hole 2a of the optical disc 2 is aligned on the turntable 23a of the disc mount 23.

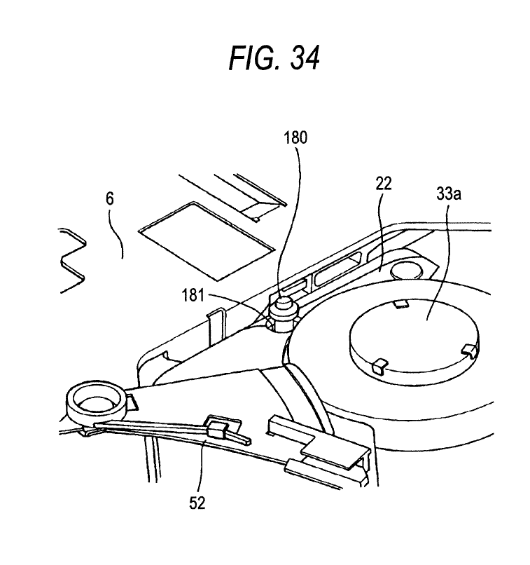

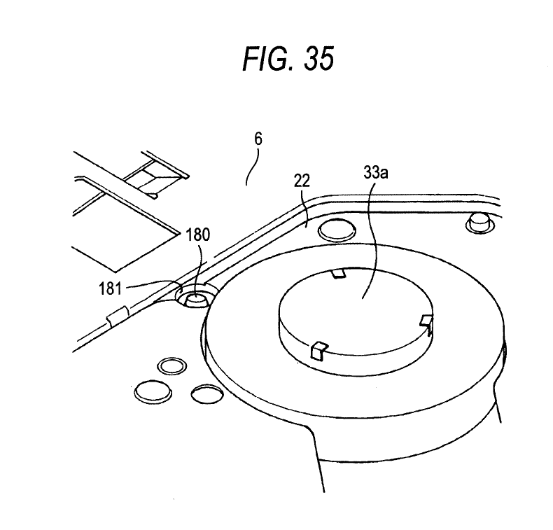

Specifically, as indicated by dashed-two dotted line in FIGS. 34 and 33(a), when the base unit 22 is moved downward to the chucking release position, the flange portion 182 of the guide pin 180 is located higher than the guide hole 181. When the optical disc 2 is conveyed to the centering position, the base chassis 27 is moved upward and the flange portion 182 passes through the guide hole 181. When the base chassis 27 is moved upward to the chucking position of the optical disc 2, as indicated by solid line in FIGS. 35 and 33(b), the first guide portion 183 of the guide pin 180 slides in the guide wall 185 swelled in the guide hole 181, whereby the flange portion 182 passes through the clearance between the guide walls 185. In this way, when the base chassis 27 is guided by the guide pin 180 so as to be moved upward, the positioning of the turntable 23a of the disc mount 23 and the central hole 2a of the optical disc 2 conveyed to the centering position is performed. Accordingly, it is possible to perform the chucking operation without applying excessive loads to the optical disc 2 or the turntable 23a.

Since the guide pin 180 and the guide hole 181 are disposed in the vicinity of the disc mount 23 at one end and the other end in the longitudinal direction of the third spindle 49 supporting the pivot movement of the base unit 22, it is possible to effectively correct the misalignment between the optical disc 2 conveyed to the centering position and the turntable 23a. Accordingly, it is possible to securely perform the alignment between the central hole 2a of the optical disc 2 and the engagement protrusion 33a of the turntable 23a.

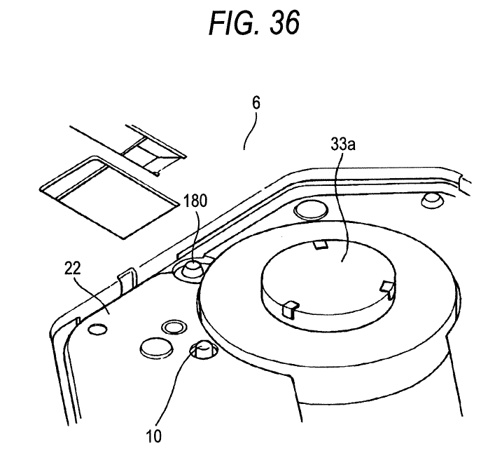

As indicated by dashed-dotted line in FIGS. 36 and 33(c), when the base unit 22 is moved downward to the recording and reproducing position, the second guide portion 184 of the flange portion 182 slides in the guide wall 185 of the guide hole 181 of the base chassis 27 so that the flange portion 182 passes through the guide hole 181. Then, the guide wall 185 is moved downward to a position where the guide wall 185 is separated from the flange portion 182. In this way, since the guide pin 180 is not in contact with the guide hole 181 in a state that the base unit 22 is moved downward to the recording and reproducing position, external disturbance such as vibration are prevented from being applied to the base chassis 27 from the bottom case 4 through the guide pin 180. Accordingly, it is possible to prevent the external disturbance from being applied to the disc rotation driving mechanism 24 or the optical pickup 25 through the guide pin 180 and from putting bad effect on the recording and reproducing characteristics.

Since the guide pin 180 is disposed at a height where the guide pin 180 does not make contact with the bottom surface of the optical disc 2 being rotated by the disc rotation driving mechanism 24, there is not any fear of destroying the information recording surface of the optical disc 2.

When the recording and reproducing operation is completed and an ejecting operation of the optical disc 2 is performed, the base unit 22 is moved downward to the chucking release position and the optical disc 2 is pushed upward against the turntable 23 by the guide pin 180, thereby releasing the chucking. In this case, in the base chassis 27, the guide hole 181 is disposed below the guide pin 180.

In the disc drive 1 according to the embodiment of the invention, the guide pin 180 also serves as a chucking releasing pin that releases the chucking of the optical disc 2. That is, the upper portion of the guide pin 180 has a semi-circular shape and the guide hole 181 of the base chassis 27 and the guide pin 180 are disposed at a non-recording area in the vicinity of the central hole 2a of the optical disc 2 mounted on the turntable 23a. Accordingly, when the base unit 22 is moved downward to the chucking release position of the optical disc 2, the optical disc 2 is pushed upward by the upper portion of the guide pin 180, thereby releasing the chucking with the turntable 23a. With this arrangement, since it is unnecessary to use additional chucking releasing pin for releasing the chucking of the optical disc 2 in addition to the guide pin 180, it is possible to decrease the number of components and reduce the weight of the disc drive 1.

It should be understood by those skilled in the art that various modifications, combinations, sub-combinations and alterations may occur depending on design requirements and other factors insofar as they are within the scope of the appended claims or the equivalents thereof.

What is claimed is:

1. A disc drive comprising:
a housing into which a disc-shaped recording medium is inserted;
a base unit including
a disc mount on which the disc-shaped recording medium inserted into the housing is mounted,
a disc rotation driving mechanism that rotates the disc-shaped recording medium mounted on the disc mount,
an optical pickup that records and/or reproduces information signals on and/or from the disc-shaped recording medium,
a pickup transferring mechanism that transfers the optical pickup in a radial direction of the disc-shaped recording medium, and
a pivot support member that pivotably supports one end thereof disposed apart from the disc mount, the components of the base unit being mounted integrally on a base; and
a base lifting mechanism that moves the base about the pivot support member between a chucking position where the disc-shaped recording medium is mounted on the disc mount and a chucking release position where the disc-shaped recording medium is dismounted from the disc mount,
wherein the pickup transferring mechanism includes a lead screw and a drive unit that rotates the lead screw, the drive unit being provided in the vicinity of the pivot support member.

2. A base unit comprising:
a disc mount on which the disc-shaped recording medium inserted into the housing is mounted,
a disc rotation driving mechanism that rotates the disc-shaped recording medium mounted on the disc mount,
an optical pickup that records and/or reproduces information signals on and/or from the disc-shaped recording medium,
a pickup transferring mechanism that transfers the optical pickup in a radial direction of the disc-shaped recording medium, and
a pivot support member that pivotably supports one end thereof disposed apart from the disc mount,
wherein the pickup transferring mechanism includes a lead screw and a drive unit that rotates the lead screw, the drive unit being provided in the vicinity of the pivot support member.
